(19) United States
(12) Patent Application Publication
(10) Pub. No.: US 2016/0023255 A1
(43) Pub. Date: Jan. 28, 2016

(54) FEEDBACK LOOP CONTROL FOR SOIL EVAPORATIVE DESORPTION

(71) Applicant: RETERRO, Pleasanton, CA (US)

(72) Inventors: Patrick Richard Brady, Pleasanton, CA (US); Brian Desmarais, Pleasanton, CA (US); Steve Bay, Pleasanton, CA (US)

(21) Appl. No.: 14/850,925

(22) Filed: Sep. 10, 2015

Related U.S. Application Data
(63) Continuation-in-part of application No. 13/419,195, filed on Mar. 13, 2012.
Application No. 13/419,195 is a continuation-in-part of application No. 14/264,024, filed on Apr. 28, 2014.
Application No. 14/264,024 is a continuation-in-part of application No. 14/312,624, filed on Jun. 23, 2014.
Application No. 14/312,624 is a continuation-in-part of application No. 14/488,317, filed on Sep. 17, 2014.
(60) Provisional application No. 62/048,794, filed on Sep. 10, 2014.

(51) Int. Cl. B09C 1/00; B09C 1/08; G05B 13/02; B09C 1/06

(52) U.S. Cl. CPC B09C 1/005; B09C 1/06; B09C 1/08; G05B 13/0205

(57) ABSTRACT

Active or closed feedback/feed forward loop controls may be used to improve operation of a thermal desorption process. Characteristics of the thermal desorption process may be monitored, e.g., carbon monoxide concentration, and then may be used to predict the end point of the thermal desorption process. Inputs and effluent treatment elements may also be modulated to further optimize the treatment time and quality (completeness) and to avoid any unwanted effects associated with excess processing. Post-treatment gas comprising non-condensed condensable hydrocarbon contaminants may be recycled as pre-treatment gas or used to heat fresh air. Mean free paths of the exhaust gas exiting a thermal desorption chamber are restricted to limit the flame propagation and explosion fronts. Temperature and concentration of flammable elements may be monitored and controlled to prevent explosion hazards. An isolation valve and a pressure relief chimney may also be coupled to the exhaust of the thermal desorption chamber.

### CLAIMS OF PRIORITY

This patent application is a continuation in part and claims priority from:
(1) U.S. patent application Ser. No. 13/419,195, filed on Mar. 13, 2012, entitled “Evaporative Desorption High Concentration Soil Contaminate Removal and Contaminate Reclamation Apparatus and Process”; which claims priority from U.S. provisional patent application Ser. No. 61/453,113, filed on Mar. 15, 2011, and U.S. provisional patent application Ser. No. 62/048,794, filed on Sep. 10, 2015.
(2) U.S. patent application Ser. No. 14/264,024, filed on Apr. 28, 2014, entitled “Flow Treatments in Evaporative Desorption Processes”.
(3) U.S. patent application Ser. No. 14/312,624, filed on Jun. 23, 2014, entitled “Controlling Processes for Evaporative Desorption Processes”.
(4) U.S. patent application Ser. No. 14/488,317, filed on Sep. 17, 2014, entitled “Agitation System for Thermal Desorption Processes”.

### FIELD OF TECHNOLOGY

This disclosure relates generally to contaminated soil reclamation and/or remediation and, more particularly, to a method, a system and/or an apparatus of feedback loop control for evaporative desorption, according to one or more embodiments.

### BACKGROUND

In one or more embodiments, the invention relates to a system, a method, and/or an apparatus for non-combustive thermal desorption of volatile contaminants from contaminated earth. The earth may include tar sand, oil sand, oil shale, bitumen, pond sediment, and tank bottom sediment. The concentration of the contaminants may be low concentration, e.g., less than about 3%, such as less than about 50,000 mg/kg of total petroleum hydrocarbon (TPH) in soil, or high concentration, e.g., greater than about 3%, such as greater than about 50,000 mg/kg of TPH in soil. The process may provide cracking of the contaminants and/or reclaiming condensable hydrocarbon contaminants, then oxidizing and/or treating the non-condensed condensable hydrocarbon contaminants and/or non-condensable hydrocarbon contaminants, which may be recycled for use as pre-treatment gas and/or used to heat fresh air to be used as pre-treatment gas.

The use of petroleum hydrocarbons as a fuel source is ubiquitous in society. Consequently, petroleum hydrocarbon products are stored and handled in great quantities. One risk associated with the storage and handling of petroleum hydrocarbons is the potential for spillages during handling or the potential for leakage during storage. Due to the negative environmental impact associated with spills and leakages of petroleum hydrocarbons, rules have been established at the local, state and federal levels. These rules primarily focus on preventing petroleum hydrocarbon releases to the environment from occurring. These rules also have provisions that require the responsible party to remediate petroleum hydrocarbon releases to the environment.

In the field of petroleum hydrocarbon remediation from soil, there are two basic approaches: applying a treatment technique to soil in place (in-situ), or applying a treatment technique to excavated soil (ex-situ). There are advantages and disadvantages for each approach and the selection of the approach may be based on the site-specific circumstances of each petroleum hydrocarbon release.

In-situ thermal desorption technologies may include techniques that involve applying heat and vacuum simultaneously to subsurface soils to vaporize volatile contaminants in the soil. Processes of vaporizing contaminants may include evaporation into the subsurface air stream, steam distillation into the water vapor or other evaporated liquid stream, boiling, oxidation, and/or pyrolysis. The vaporized water or liquid, contaminants, and organic compounds are drawn by the vacuum in a counter-current direction to the flow of heat into the source of vacuum.

Ex-situ thermal desorption technologies may include techniques that involve mechanical agitation of the soil during the heating process, which involve mechanical agitation and operate in a continuous process where the soil is continuously introduced to the process and is mechanically moved through the process apparatus until treatment is complete, and then is continuously discharged to a container for disposal or re-use.

Alternatively, the soil may be treated in a static configuration of an ex-situ thermal desorption system, in which a given amount of soil is introduced to the treatment chamber. The soil configurations may include pile arrangement and container arrangements.

Nearly all the prior art processes use combustion of fossil fuel as a heat source. This may have the consequence of forming products of incomplete combustion, oxides of nitrogen, and other greenhouse gases as a by-product.

Combustion also may potentially add unburned hydrocarbons to the process exhaust gas if strict control of the combustion process is not maintained.

There is a need for an ex-situ static process that is labor, time and energy efficient in the treatment process, and is environmentally friendly.

### SUMMARY

Disclosed are a system, a method, and/or an apparatus of a feedback loop control for evaporative soil desorption.

In one or more embodiments, a system, a method, and/or an apparatus to treat contaminated soil are provided, including a closed-loop control system with direct feedback based on carbon monoxide concentration data inputs from a carbon monoxide concentration monitor. The system may avert a combustion event and/or improve desorption efficiency of hydrocarbon contaminants. Based on the carbon monoxide concentration data inputs, the system may include a method of a fresh air rinse of the treated soil located within a treatment chamber to completely oxidize remaining hydrocarbon contaminants.

In one or more embodiments, a method of adjusting a concentration of the non-condensed condensable hydrocarbon contaminants may be used as additional fuel to reheat the post-treatment gas for use as recycled pre-treatment gas and/or to heat fresh air for use as pre-treatment gas is disclosed. After condensing condensable hydrocarbon contaminants from the post-treatment gas at a heat exchanger, a gas extraction fan may discharge the post-treatment gas comprising remaining non-condensed condensable hydrocarbon contaminants and/or non-condensable hydrocarbon contaminants through a flame arrester and then to a thermal oxidizer or other type of oxidizer such as a catalytic oxidizer. The condensation of the condensable hydrocarbon contaminants at the heat exchanger may be adjusted to provide more or less non-condensed condensable hydrocarbon contaminants, which is then used as additional fuel in the oxidizer. The adjustment of the cooling at the heat exchanger to produce varying concentrations of the non-condensed condensable hydrocarbon contaminants may be based on the total net concentration of non-condensed condensable hydrocarbon contaminants and noncondensable hydrocarbon contaminants within the post-treatment gas. In any embodiment the thermal oxidizer or oxidizer may be replaced with a catalytic oxidizer and all associated processes, methods, and apparatuses, necessitated may be changed, added or removed. In any embodiment, any thermal oxidizer may be replaced with any type of oxidizer with any method of function and all associated processes, methods and apparatus necessitated may be changed, added or removed. In the Figures and embodiments, the thermal oxidizer may be representative of any type of oxidizer and the associated apparatuses, processes and methods. In any embodiment, in addition to the methods, apparatuses and processes mentioned, such as oxidation or inerting gases, another form of control device may be used solely or simultaneously such as a carbon absorber or other substance or method which is able to perform absorption for any intended reason such as to remove containments, keep temperatures within a range or alter the auto-ignition temperature of the substances within a range.

In one or more embodiments, a thermal desorption process can be used to treat contaminated soil in static arrangement, which is inherently safe, for example, due to the absence of open flame heating. In an evaporative desorption process, an input gas, such as air, can be heated and directed into a container of contaminated soil. The contaminants within the soil are evaporated and the process effluent is directed to a variety of collection or destruction systems.

In one or more embodiments, systems and methods are provided for controlling inputs to a thermal desorption chamber, for example, controlling a flow rate or a temperature of an input gas, to improve the efficiency of the treatment process, such as shortening the process time, minimizing the power consumption, or preventing overload conditions such as exceeding an operating temperature of the effluent treatment equipment.

In one or more embodiments, automatic operations of a thermal desorption process are provided. The suitability or completeness of the treatment can be determined by analyzing the output of these instruments and to automatically cease processing at the optimum moment to conserve energy and limit costs.

In one or more embodiments, active or closed loop controls of a thermal desorption process are provided. Characteristics of the thermal desorption process can be monitored, and then can be used to predict the end point of the thermal desorption process. Inputs and effluent treatment elements can also be modulated to further optimize the treatment time and quality (completeness) and to avoid any unwanted effects associated with excess processing.

In one or more embodiments, feed forward process optimizations of a thermal desorption process are provided. Processing data from a previous batch or series of batches can be used to formulate or to develop self-correcting or learning algorithms that can be used to modulate the input or effluent to further optimize the subsequent processing parameters using statistical process control computations. This data may be combined with pre-treatment sample results to create a predictive process optimization. In addition, pre-treatment sample results may be used without batch processing data to obtain a similar predictive process optimization.

In one or more embodiments, low humidity gas can be used in an evaporated desorption process. The low humidity gas can improve, e.g., shorten, the process time of decontaminating the contaminated soil, for example, by absorbing more liquid vapor from the contaminated soil. The low humidity gas can be less than 20% humidity, such as less than 10% humidity or 5% humidity.

In one or more embodiments, the input gas to the thermal desorption chamber can have a two-step characteristic. In the beginning, the input gas can have high temperature and low flow rate. The high temperature can speed up the heating of the contaminated soil. The low flow rate can improve the efficiency of the transfer of thermal energy from the input gas to the contaminated soil. After the soil is heated, for example, when the temperature of the exhaust gas reaches a certain temperature such as between 150 and 250 F (or between 200 and 220 F, or about 212 F), the input gas can have lower temperature and higher flow rate. The high flow rate can shorten the process time, for example, by quickly transport the evaporated contamination from the soil to the exhaust pipe. The low temperature can reduce the power consumption of the thermal desorption process, and does not affect, or minimally affect, the speed of the thermal desorption process, for example, due to the generated thermal energy from the contaminated hydrocarbons in the contaminated soil.

In one or more embodiments, parameters of the thermal desorption process, such as temperature, the oxygen concentration, the pressure, the gas constituents, the humidity, the flammability of the effluent gas (e.g., the exhaust gas), can be monitored and then used to optimize the thermal desorption process.

In one or more embodiments, thermal desorption process can be used to treat contaminated soil in static arrangement, which is inherently safe, for example, due to the absence of open flame heating.

In one or more embodiments, systems and methods are provided for treating an immediate exhaust of a thermal desorption chamber, for example, to improve the safety of the treatment process, such as reducing potential explosion or flammability when treating highly contaminated soil.

In one or more embodiments, systems and methods are provided to monitor a temperature of the exhaust gas of the thermal desorption chamber. If this temperature is below an auto-ignition temperature of the contaminants in the soil, explosion hazard can be reduced or prevented. In one or more embodiments, this temperature can be used to control a thermal energy input to the thermal desorption chamber, for example, to regulate a heater that heats the treatment gas to limit the exhaust temperature to below the auto-ignition temperature. The contaminants can include different types of hydrocarbons with different auto-ignition temperature, so a reasonable upper end temperature of 500 F (260 C) or 400 F (204 C) can be used to limit the temperature of the exhaust gas.

In one or more embodiments, systems and methods are provided to monitor a hydrocarbon concentration of the exhaust gas of the thermal desorption chamber. If this concentration is outside the range of flammability of the hydrocarbons, explosion hazard can be reduced or prevented. In one or more embodiments, this concentration can be used to control an input flow rate of the treatment gas to the thermal desorption chamber, for example, to regulate, e.g., by increasing or decreasing, the treatment gas to confine the exhaust concentration to outside the flammability range. The contaminants can include different types of hydrocarbons with different flammability range, so a reasonable range between 5 vol % and 15-30 vol %, such as between 5 vol % and 25 vol % or between 5 vol % and 20 vol %, can be used.

In one or more embodiments, systems and methods are provided to direct flame propagation and explosion fronts to a relief chimney to prevent damage to property and personnel. An isolation valve and a pressure relief chimney can be coupled to the exhaust of the thermal desorption chamber. The isolation valve can be configured to sense flame propagation and explosion fronts, and can be closed. A pressure relief valve can be open to guide the flame propagation and explosion fronts to a safe exhaust.

In one or more embodiments, systems and methods are provided to cool the exhaust gas of the thermal desorption chamber, for example, to a temperature below an auto-ignition temperature of the contaminants in the exhaust gas. The exhaust gas, when exiting the thermal desorption chamber, can be in the range of 1000 F (538 C). The exhaust gas can be cooled to a temperature of below 500 F (260 C) or 400 F (204 C) before being admitted to an exhaust gas treatment, for example, a heat exchanger to recover the hydrocarbon contaminants. A cooling jacket, for example, using circulated coolant to regulate the temperature, can be used to reduce the temperature of the exhaust gas exiting the thermal desorption chamber. Alternatively, or additionally, cooling gas, such as fresh air from the ambient, can be provided to the exhaust gas stream. Cooling liquid, such as room temperature water or chilled oil, can be misted, e.g., fine droplet spraying, in the exhaust stream. Cryogenic liquid can also be used to decrease temperatures within the gas exhaust stream. In one or more embodiments, systems and methods are provided to restrict the mean free paths of the exhaust gas exiting the thermal desorption chamber, for example, to limit the flame propagation and explosion fronts. A section of the gas exhaust conduit from the thermal desorption chamber can be filled with a porous media, which can assist in reducing or eliminating the potential explosion hazard in the conduit. The sizes of the conduit and the porous media can be designed to provide adequate flow conductance of the exhaust gas from the thermal desorption chamber to the treatment section.

### BRIEF DESCRIPTION OF THE DRAWINGS

The embodiments of this invention are illustrated by way of example and not limitation in the figures of the accompanying drawings, in which like references indicate similar elements:

FIG. 1 is an expansive view of a thermal desorption soil reclamation and remediation system, according to one or more embodiments.

FIG. 2 is a treatment chamber view showing schematic details of the treatment chamber of FIG. 1, according to one or more embodiments.

FIG. 3 is a data processing view illustrating the connections of the data processing system 168 from FIG. 1 to various apparatuses for controlling corresponding parameters in the feedback system, according to one or more embodiments.

FIG. 4 is a graphical view of the relationships between carbon monoxide concentration, oxygen concentration, and combustion, according to one or more embodiments.

FIG. 5 is an expansive back view of the thermal desorption soil reclamation and remediation system of FIG. 1, according to one or more embodiments.

FIG. 6 is a soil box top view of the soil box showing the arrangement of the post-treatment gas exit pathway of FIG. 1, according to one or more embodiments.

FIG. 7 is a closed view of the treatment chamber of FIG. 1, according to one or more embodiments.

FIG. 8 is an open view of the treatment chamber of FIG. 1, according to one or more embodiments.

FIG. 9 is a loading view of the treatment chamber of FIG. 1, according to one or more embodiments.

FIG. 10 is a perspective dual view of the treatment chamber of FIG. 1 showing two dual treatment areas integrated into a single treatment chamber, according to one or more embodiments.

FIG. 11 is a front dual view of the treatment chamber of FIG. 1 showing two connected treatment chambers, according to one or more embodiments.

FIG. 12 is a comparison view of air-rinsed soil and treated soil, according to one or more embodiments.

FIG. 13 is a flow diagram of a thermal desorption process, according to one or more embodiments.

FIG. 14 is a flow diagram of an alternative embodiment for a thermal desorption process, according to one or more embodiments.

FIG. 15 is a flow diagram of a thermal desorption process whereby concentration of noncondensed condensable hydrocarbon contaminants may be adjusted, according to one or more embodiments.

FIG. 16 is a flow diagram illustrating an alternative embodiment of a thermal desorption process whereby concentration of non-condensed condensable hydrocarbon contaminants may be adjusted through the adjustment of the cooling of the condensable hydrocarbon contaminants in the post-treatment gas at the heat exchanger, according to one or more embodiments.

FIG. 17A-17C illustrate flow diagrams for thermal desorption processes, according to one or more embodiments.

FIG. 18A-18C illustrate flow diagrams for thermal desorption processes, according to one or more embodiments.

FIG. 19A-19B illustrate flow diagram for flame propagation and explosion prevention, according to one or more embodiments.

FIG. 20A-20C illustrate flow diagrams for thermal desorption processes, according to some embodiments.

FIG. 21A-21C illustrate flow diagrams for thermal desorption processes, according to one or more embodiments.

FIG. 22A-22C illustrate flow diagrams for thermal desorption processes, according to one or more embodiments.

FIG. 23A-23B illustrate flow diagrams for thermal desorption processes, according to one or more embodiments.

FIG. 24A-24B illustrate flow diagrams for thermal desorption processes, according to one or more embodiments.

FIG. 25 illustrates a thermal desorption process with additives, according to one or more embodiments.

FIG. 26 illustrates a thermal desorption process with additives, according to one or more embodiments.

FIG. 27 illustrates a thermal desorption process with additives, according to one or more embodiments.

Other features of the present embodiments will be apparent from the accompanying drawings and from the detailed description that follows.

### DETAILED DESCRIPTION

Disclosed are a method, a system, and/or an apparatus of a feedback loop control for evaporative soil desorption. Although the present embodiments have been described with reference to specific example embodiments, it will be evident that various modifications and changes may be made to these embodiments without departing from the broader spirit and scope of the various embodiments.

In one or more embodiments, a thermal desorption technique may be applied to a static configuration of soil in a batch process using a container arrangement. The process may be designed to use temperatures based on testing of samples of the contaminated soil to be treated. Contaminates may vary widely and therefore the temperatures used will vary to obtain an efficient remediation process for the contaminant of interest. The treatment process for thermal desorption of hydrocarbon contaminants from excavated soil may provide efficient contaminant removal by handling the soil in a thermally conductive treatment vessel that may be contained in an insulated treatment chamber for treatment. The soil may be treated with fresh air that is dried and electrically heated prior to introduction to the treatment chamber. Excavating the soil directly into the treatment vessel may allow the treated soil to be returned to the final disposition site in the same vessel, minimizing soil handling. The treatment vessel may consist of a floor, sides and ends to contain contaminated soil that remains exposed at the top of the vessel, and a gas exit pathway arranged at a predetermined location within the contaminated soil such that gases in the contaminated soil flow to the gas exit pathway. The treatment chamber may have an opening so the treatment vessel may be inserted or removed, an incoming air penetration to direct the incoming air to locations external to the treatment vessel and a gas exit pathway penetration arranged so the gases in the pathway exit the treatment chamber. An air dryer, air blower and electric air heater are arranged such that the incoming air to the treatment chamber is dried and heated upon entering the treatment chamber. A gas extraction blower may direct the gases in the gas exit pathway penetration to exit the treatment chamber. This air may be cooled prior to flowing through the blower.

The process flow path then may be for dry, heated incoming air to surround the treatment vessel transferring heat to the contaminated soil through the treatment vessel floor, sides, and ends inducing the migration of contaminates through the soil to the gas exit pathway, and then the heated air then may flow through the contaminated soil, directly heating the soil before entering the gas exit pathway and exiting the chamber.

Contaminated earth (soil and rocks or other earthy material) that has been excavated is placed in a thermally conductive treatment container that is then placed in a thermally insulated treatment chamber. Heated pre-treatment gas is introduced to the treatment chamber and flow through the treatment chamber and contaminated soil. Treatment gases containing contaminates are withdrawn from the treatment chamber and cooled and separated to reclaim and separate the condensable contaminates. The resultant gaseous mixture is treated in a combustion and/or electrically heated thermal oxidizer or any other type of oxidizer such as a catalytic oxidizer. The oxidizer effluent gas is cooled to a desired temperature and partially recycled to the treatment chamber as the pre-treatment gas, with the remainder released to the atmosphere. Fresh air is added to the pre-treatment gas and/or post-treatment gas in a controlled manner to provide a treatment gas oxygen content, but maintain the mixture in an inert condition that is outside the flammable mixture concentration envelope for the contaminants of interest. In any embodiment, pre-treatment, post-treatment or treatment gasses may also be inerted to adjust or keep oxygen content or other contents within a range for a certain process, such as a range that is outside the range of auto-ignition, but inside a range for pyrolysis to provide further processing.

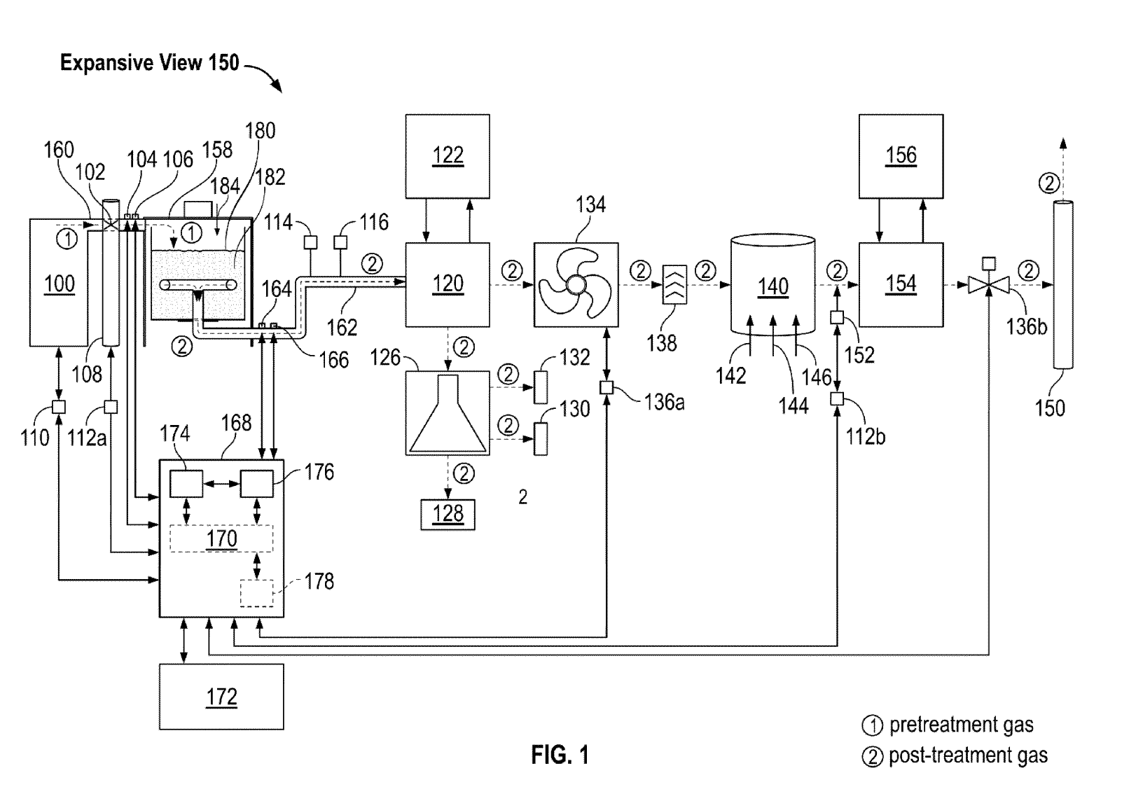

FIG. 1 is an expansive view of a thermal desorption soil reclamation and remediation system, according to one or more embodiments.

Particularly, FIG. 1 illustrates an expansive view 150, according to one or more embodiments. The embodiments of FIG. 1 introduces a heater 100, a valve assembly 102, an inlet temperature sensor 104, an inlet oxygen sensor 106, an air chimney 108, a temperature electronic controlling device 110, an oxygen electronic controlling device 112a, an oxygen electronic controlling device 112b, an outlet oxygen sensor 114, an outlet temperature sensor 116, a heat exchanger I 120, a heat exchanger cooler I 122, a phase separator 126, a heavy contaminants tank 128, a water or liquid tank 130, a light contaminants tank 132, a gas extraction fan 134, a flow electronic controlling device 136a, a flow electronic controlling device 136b, a flame arrester 138, a thermal oxidizer 140, a secondary air 142, a combustion air 144, a fuel inlet 146, a stack 150, a tertiary air valve 152, a heat exchanger II 154, a heat exchanger cooler II 156, a treatment chamber 158, a pre-treatment gas inlet 160, a post-treatment gas exit pathway 162, a carbon monoxide detector 164, a carbon monoxide concentration monitor 166, a data processing system 168, an algorithm 170, a graphical user interface 172, a processor 174, a memory 176, a datum 178, a soil box 180, a contaminated soil 182, and a nitrogen supply 184.

One or more soil box 180 may be placed in the treatment chamber 158. The treatment chamber 158 may be insulated to prevent heat loss. The soil box 180 may be open on top and may comprise the post-treatment gas exit pathway 162. The soil box 180 may be filled with the contaminated soil 182, and may then be installed in the treatment chamber 158 for treatment, and may be removed after treatment is complete. The soil box 180 may provide for a batch process for contaminated soil 182. Pre-treatment gas may be introduced to the treatment chamber 158 through the pre-treatment gas inlet 160. The pre-treatment gas may be heated, desiccated, and/or inerted. The pre-treatment gas may pass through the contaminated soil 182 in the soil box 180 to the post-treatment gas exit pathway 162, and then flow out of the treatment chamber 158. The pre-treatment gas follows a flow path through the contaminated soil 182 in the soil box 180 to the post-treatment gas exit pathway 162 that provides a passage out of the treatment chamber 158 for the post-treatment gas comprising contaminants from the treatment chamber 158.

In one or more embodiments, the pre-treatment gas can have controlled humidity for optimizing the treatment process. For example, a wet soil may accept a low humidity treatment, e.g. dry gas, while a dry soil can accept higher humidity treatment gas, e.g. wetter gas.

The resultant post-treatment gas may comprise condensable hydrocarbon contaminants and non-condensable hydrocarbon contaminants, which may be recovered. A recovering assembly may be coupled to the post-treatment gas exit pathway 162 to recover all or a portion of the hydrocarbon contaminants in the post-treatment gas. The recovering assembly may comprise heat exchanger I 120, its associated heat exchanger cooler I 122, which may provide cooling fluid (e.g. water, glycol, and etc.) to the heat exchanger I 120; and the gas extraction fan 134, which may provide the flow of post-treatment gas from the treatment chamber 158 through the heat exchanger I 120. The cooling in the heat exchanger I 120 condenses condensable hydrocarbon contaminants and the resultant condensate is directed to an outlet that flows to the phase separator 126. Heavy contaminants, light contaminants, and water or other liquids are separated in the phase separator 126 and flow through outlets to heavy contaminants tank 128, light contaminants tank 132, and water or liquid tank 130. The remaining residues may be exhausted to a vent stack 150, and the recovered condensate may be further processed.

The heater 100 may be configured to heat pre-treatment gas prior to injection into the treatment chamber 158. The heater 100 may be coupled with a desiccant unit to lower the humidity of the pre-treatment gas and/or a blower to flow the pre-treatment gas into the treatment chamber 158. The desiccant unit may be placed prior to or after the blower unit. By lowering the humidity of the pre-treatment gas to below 10% or below 5% humidity level, significantly faster and more efficient desorption of the contaminants can be achieved.

The gas extraction fan 134 may discharge the mixture of post-treatment gas, condensable hydrocarbon contaminants, and/or non-condensable hydrocarbon contaminants through flame arrester 138, and then to the thermal oxidizer 140. The concentrations of non-condensed condensable hydrocarbon contaminants and/or non-condensable hydrocarbon contaminants affect fuel consumption in the thermal oxidizer 140. Higher concentrations of non-condensed condensable hydrocarbon contaminants are generally encountered in the latter stages of a treatment cycle on a batch. In the earlier stages of treatment, the cooling at heat exchanger I 120 may be adjusted to provide additional non-condensed condensable hydrocarbon contaminants as extra fuel to the thermal oxidizer 140 to minimize supply fuel addition to the process. The residual hydrocarbon contaminants in the resultant post-treatment gas may be destroyed in the thermal oxidizer 140 by the addition of secondary air to the treatment gas, and then a mixture of combustion air and fuel (e.g. natural gas, propane, and etc.) to the thermal oxidizer 140.

Alternatively, electric energy heating in the thermal oxidizer 140 may be used in place of the energy of fuel combustion, or as a supplement. A flameless thermal oxidizer 140 may facilitate use of the invention in locations that preclude combustion equipment, such as on an offshore oil rig or the like.

In addition to purification by destruction of the hydrocarbon contaminants in the post-treatment gas by the thermal oxidizer 140, it may also remove remaining oxygen gas.

The discharge post-treatment gas from the thermal oxidizer 140 may flow to heat exchanger II 154, which may comprise an adjustable cooling fluid from the associated heat exchanger cooler II 156. This discharge is conditioned for recycle as pre-treatment gas by the addition of tertiary air controlled by the tertiary air valve 152. The tertiary air addition is controlled to maintain the desired inert oxygen concentration in the pre-treatment gas. Typically, the range of 3% to 9% may be required to maintain the oxygen concentration outside the explosive envelope for contaminants in the treated soil, and may provide sufficient oxygen for reaction with the contaminants. Also, the inerted substances, at a particular concentration, may provide characteristics for other alterations such as pyrolysis. The cooling by heat exchanger II 154 is controlled to maintain the desired temperature of the pre-treatment gas going into the treatment chamber 158, typically 800 to 1000 degrees Fahrenheit.

In one or more embodiments, an objective of the present invention is to thermally desorb varying types and amounts of hydrocarbon contaminants within soil batches, while preventing or minimizing harmful gases from entering the atmosphere. As such, an optimum temperature or temperature range may be used to prevent or minimize production of the harmful gases, such as oxides of nitrogen (NOₓ), oxides of sulfur (SOₓ), and other particulate matters that may be of interest to regulatory bodies and environmentalists. In one or more embodiments, a temperature range of approximately 800 to 1,000 degrees Fahrenheit may be the optimum range to desorb contaminates within a soil batch contained within a treatment chamber. At high temperature, e.g., above 1,000 F, harmful compounds may be produced, such as NOₓ, SOₓ, and etc. On the other hand, temperatures below 800 F may not be sufficient in efficiently evaporating all of the various types of hydrocarbon contaminants that may be found in a contaminated soil batch. For reference, triacontane (C₃₀H₆₂) has a boiling point of approximately 450 C (842 F), one of a higher temperature among known hydrocarbons.

The discharge from heat exchanger I 154 may be split and the desired flow may be used as pre-treatment gas to the treatment chamber 158. The flow electronic controlling device 136b may maintain the desired flow. The balance may flow to the stack 150, which may then discharge to the environment.

Process control may be aided by measurement of the pre-treatment gas oxygen content by the inlet oxygen sensor 106, the pre-treatment gas temperature by the inlet temperature sensor 104, post-treatment gas oxygen content by the outlet oxygen sensor 114, and the post-treatment gas temperature by the outlet temperature sensor 116. Other instruments may be used for monitoring and controlling of the individual components of the process. The nitrogen supply 184 may be provided to the insulated treatment chamber 158 for use in startup and in case the oxygen content of the pre-treatment gas is higher than the desired value.

In one or more embodiments, systems and methods may be provided to regulate pre-treatment gas, e.g. temperature and flow rate, to the treatment chamber 158. The regulation may be based on time, on data from previous processes, or on measured temperature of the post-treatment gas of the treatment chamber 158. The outlet temperature sensor 116 may be placed at or near the post-treatment gas exit pathway 162 to measure the temperature of the post-treatment gas that exits the treatment chamber 158. The outlet temperature sensor 116 (and the inlet temperature sensor 106) may be a thermocouple. The measured temperature may be used by the algorithm 170 of memory 176 coupled to the processor 174 of the data processing system 168 to control a thermal energy input to the treatment chamber 158, e.g., by regulating the heater 100 that heats the pre-treatment gas or regulate the blower that controls the flow of the pre-treatment gas. The contaminants can include different types of hydrocarbons, so a temperature between 250 F and 150 F, such as 212 F, may be used to change the flow rate or the temperature of the pre-treatment gas.

The outlet temperature sensor 116 may be placed at the post-treatment gas exit pathway 162, such as at or near the exit of the treatment chamber 158. A feedback may be provided to a data processing system 168, which may be configured to control or regulate the blower, desiccant unit, and/or the heater 100.

The desiccant unit may be optionally used to lower the humidity of the pre-treatment gas. The blower may be configured to provide a desired flow rate of pre-treatment gas to the treatment chamber 158. The heater 100 may be configured to heat the pre-treatment gas for providing a dry, hot pre-treatment gas to the treatment chamber 158.

The feedback may be used to regulated, e.g. increasing or decreasing a thermal energy provided to heat the pre-treatment gas. For example, at the beginning of a treatment cycle, the post-treatment gas temperature at the outlet temperature sensor 116 may be low, and the heater 100 may be turned on to heat the pre-treatment gas. When the post-treatment gas temperature exceeds a predetermined threshold temperature, thermal energy from the heater 100 may be reduced or turned off. The predetermined threshold temperature may be set before a treatment cycle, e.g., by assessing the characteristics of the contaminated soil 182 from a sample treatment run. The predetermined threshold temperature may be determined from previous runs, e.g., by continuously collecting the characteristics of the contaminated soil 182 in previous batches. In general, a predetermined threshold temperature between 100 F to 300 F, 150 F to 250 F, or 220 F to 230 F may be used.

In one or more embodiments, a thermal desorption process with improved safety may be provided. At temperatures below the auto-ignition temperature of hydrocarbons (which is about 400 F for hydrocarbon chains n-CxHy with x>8, and about 500 F for x>5), the conveyance of post-treatment gas, which is carrying the hydrocarbon contaminants, may have minimum explosion hazard. Thus in one or more embodiments, special considerations are provided in a conduit section until the post-treatment gas temperature is reduced to below the auto-ignition temperature. Alternatively, the post-treatment gas temperature may be limited to below the auto-ignition temperature as soon as it exits the treatment chamber 158.

In one or more embodiments, systems and methods may be provided to regulate a temperature of the post-treatment gas of the treatment chamber 158 to reduce or prevent potential explosion hazards.

The outlet temperature sensor 116, such as a thermocouple, may be placed at or near the post-treatment gas exit pathway 162 of the treatment chamber 158 to measure the temperature of the post-treatment gas that exits the treatment chamber 158. The measured temperature may be used by the algorithm 170 of memory 176 coupled to the processor 174 of the data processing system 168 to control a thermal energy input to the treatment chamber 158, e.g., by regulating the heater 100 that heats the pre-treatment gas. The contaminants may include different types of hydrocarbons with different auto-ignition temperatures, so a reasonable upper end temperature of 500 F or 400 F may be used to limit the temperature of the post-treatment gas.

In one or more embodiments, input temperature regulation may be reflected in the post-treatment gas temperature, measured by the outlet temperature sensor 116. For example, heater 100 may be used to heat the pre-treatment gas. The heater 100 may be controlled through a variable frequency drive assembly that will automatically adjust heat delivery based on a temperature feedback from the post-treatment gas. Limiting the temperature of the post-treatment gas to, e.g., 400 F may reduce the temperature below an auto-ignition temperature. Bench studies show significant hydrocarbon vapor production with post-treatment gas temperature of 400 F. Redundant thermocouples placed at the soil box 180 exit may be set at the predetermined threshold temperature setting.

Within the soil bed, temperatures may exceed 400 F; however, the pre-treatment gas is contained within the soil and subsequently cooled between the moving oxidation front and the post-treatment gas exit pathway 162. The vapors are in porous flow conditions, which acts similar to a spark or flame arrestor. The vapor pathways are non-linear, which will not propagate a spark or flame.

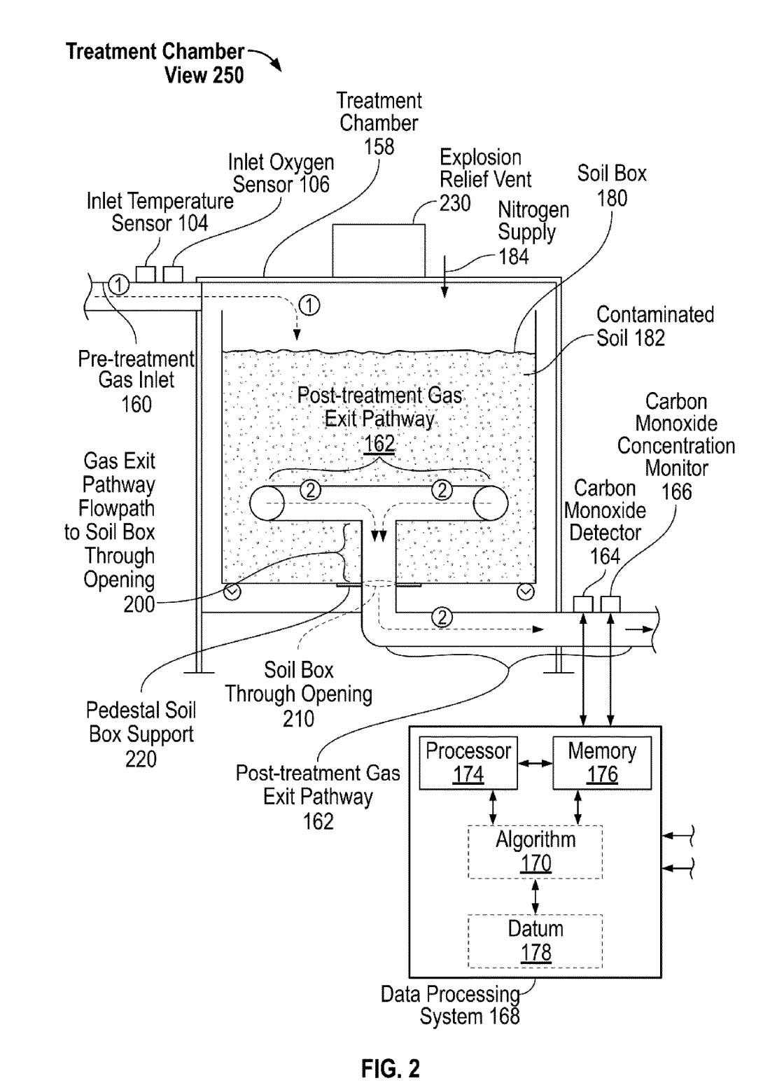

FIG. 2 is a treatment chamber view showing schematic details of the treatment chamber of FIG. 1, according to one or more embodiments.

Particularly, FIG. 2 illustrates a treatment chamber view 250, according to one or more embodiments. The embodiments of FIG. 2 describes the inlet temperature sensor 104 from FIG. 1, the inlet oxygen sensor 106 from FIG. 1, the treatment chamber 158 from FIG. 1, the pre-treatment gas inlet 160 from FIG. 1, the post-treatment gas exit pathway 162 from FIG. 1, the carbon monoxide detector 164 from FIG. 1, the carbon monoxide concentration monitor 166 from FIG. 1, the data processing system 168 from FIG. 1, the algorithm 170 from FIG. 1, the processor 174 from FIG. 1, the memory 176 from FIG. 1, the datum 178 from FIG. 1, the soil box 180 from FIG. 1, the contaminated soil 182 from FIG. 1, the nitrogen supply 184 from FIG. 1, and introduces a gas exit pathway flow path to soil box through opening 200, a soil box through opening 210, a pedestal soil box support 220, and an explosion relief vent 230.

The treatment chamber 158 may be insulated. The soil box 180 may be mounted within the treatment chamber 158. The open-top soil box 180 may be supported by rollers or steel rails at the bottom. The treatment chamber 158 may accept hot and dry pre-treatment gas, such as desiccated air. The pre-treatment gas may enter the contaminated soil 182, and may flow towards the post-treatment gas exit pathway 162, carrying away the contaminants within the contaminated soil 182 to the exhaust line. The soil box 180 may comprise the post-treatment gas exit pathway 162 located near the bottom of the soil box 180. A section located within the soil box 180 of the post-treatment gas exit pathway 162 may be perforated to allow flow of post-treatment gas from the surrounding soil to enter the post-treatment gas exit pathway 162. The soil box 180 may be installed on the pedestal soil box support 220 that may provide a flow path from the post-treatment gas exit pathway 162 to allow post-treatment gas comprising condensable hydrocarbon contaminants and/or non-condensable hydrocarbon contaminants to exit the treatment chamber 158.

The heater 100 from FIG. 1 may be configured to heat pre-treatment gas prior to injection into the treatment chamber 158. The heater 100 may be coupled with a desiccant unit to lower the humidity of the pre-treatment gas and/or a blower to flow the pre-treatment gas into the treatment chamber 158. The desiccant unit may be placed prior to or after the blower unit. By lowering the humidity of the pre-treatment gas to below 10% or below 5% humidity level, significantly faster and more efficient desorption of the contaminants may be achieved.

In one or more embodiments, feedback control for a thermal desorption process are provided, e.g., to conserve energy, and to limit costs. Temperature of the exhaust also may be monitored, and may be used to regulate the flow rate and temperature of the pre-treatment gas. Alternatively or in addition, feed forward process optimizations may be used. Post-treatment gas temperature graphs from previous batch runs may be used to assist the currently measured post-treatment gas temperature to provide better performance.

In one or more embodiments, systems and methods are provided to regulate the pre-treatment gas, e.g. temperature and flow rate, to the treatment chamber 158. The regulation may be based on time, data from previous batch treatments, and/or on measured temperature of the post-treatment gas. The outlet temperature sensor 116, such as a thermocouple, may be placed at or near the post-treatment gas exit pathway 162 of the treatment chamber 158 to measure the temperature of the post-treatment gas that exits the treatment chamber 158. The measured temperature may be used to control a thermal energy input to the treatment chamber 158, e.g., by regulating heater 100 that heats the pre-treatment gas or regulate the blower that controls the flow of the pre-treatment gas. The contaminants may include different types of hydrocarbons, so a temperature between 250 F and 150 F, such as 212 F, may be used to change the flow rate or the temperature of the pre-treatment gas.

In one or more embodiments, a concentration measurement device, such as a laser assembly, may be placed at or near the exit at the treatment chamber 158, such as the post-treatment gas exit pathway 162, e.g., a laser may send a laser beam across the post-treatment gas exit pathway 162 across the post-treatment gas flow. An intensity measurement device may receive the signal from the laser. If the laser is tuned to the hydrocarbon species in the post-treatment gas, a portion of the laser beam may be absorbed or scattered due to the presence of the hydrocarbons. Thus, the measured intensity signal at an intensity measuring device may indicate a concentration of the hydrocarbons in the post-treatment gas. A feed may be provided to heater 100 and blower, which may be configured to provide the dry hot pre-treatment gas to the treatment chamber 158. The feedback may be used to regulate, e.g. increasing or decreasing, a thermal energy provided to heat the pre-treatment gas. If the measured hydrocarbon concentration is lower than a flammable limit, e.g. 20, 25, or 30 vol % concentration of hydrocarbons in the post-treatment gas, a lower flow rate of the pre- and post-treatment gas may be provided to increase the concentration to be outside the flammability range. Similarly, if the measured hydrocarbon concentration is higher than a flammable limit, e.g. 5 vol % concentration of hydrocarbons in the treatment gas flow stream, a higher flow rate of the pre- and post-treatment gas may be provided to lower the concentration to be outside the flammability range. In one or more embodiments, a combination of temperature and concentration monitoring may be used to regulate the post-treatment gas from the treatment chamber 158.

The soil box 180, which may be open on top and may comprise the post-treatment gas exit pathway 162, is installed in the treatment chamber 158 for treatment of contaminated soil batches, and then removed after treatment is complete. The treatment chamber 158 may be insulated. The process may provide for pre-treatment gas injected into the treatment chamber 158 through a pre-treatment gas inlet 160. Circle ‘1’ shows the flow path of the pre-treatment gas into the treatment chamber 158. The pre-treatment gas may be heated and/or inerted prior to injection into the treatment chamber 158. The pre-treatment gas may be monitored by an inlet temperature sensor 104 and/or an inlet oxygen sensor 106, in addition to any other parameter sensors.

After completion of treatment of a contaminated soil batch, a gas extraction fan 134 from FIG. 1 may discharge post-treatment gas out of the treatment chamber 158 through the post-treatment gas exit pathway 162. Circle ‘2’ shows the flow path of the post-treatment gas from the treatment chamber 158. Post-treatment gas exiting the post-treatment gas exit pathway 162 may comprise condensable hydrocarbon contaminants and/or non-condensable hydrocarbon contaminants that are removed from the contaminated soil batch through the treatment process. A carbon monoxide detector 164 and a carbon monoxide concentration monitor 166 may be installed at the post-treatment gas exit pathway 162 and/or within the treatment chamber 158 to detect carbon monoxide and monitor carbon monoxide concentration of the post-treatment gas, respectively.

In a preferred embodiment, the carbon monoxide concentration data from the carbon monoxide concentration monitor 166 may be outputted to the data processing system 168. An algorithm 170 may be used to compute process inputs of treatment parameters to avert a combustion event within the treatment chamber 158 and/or to achieve an optimum efficiency of a desorption rate. The parameters may comprise pre-treatment gas oxygen concentration, pre-treatment gas hydrocarbon concentration, pre-treatment gas temperature, pre-treatment gas flow, pre-treatment gas humidity, post-treatment gas oxygen concentration, post-treatment gas hydrocarbon concentration, post-treatment gas temperature, post-treatment gas flow, and/or post-treatment gas humidity. A feedback may be provided to a variety of corresponding devices to control each parameter, such as the air chimney 108 from FIG. 1 to regulate the pre- and/or post-treatment gas oxygen concentrations, the heater 100 from FIG. 1 to regulate the pre- and/or post-treatment gas temperatures, a dryer to regulate the pre- and post-treatment gas humidity, and/or the gas extraction fan 134 from FIG. 1 to regulate the pre- and/or post-treatment hydrocarbon concentrations, and/or, the pre- and/or post-treatment gas flow.

In one or more embodiments, carbon monoxide concentration of a soil batch within a treatment chamber 158 may be used as an early indicator of combustion of the hydrocarbon contaminants in the soil batches, and/or as an indicator of incomplete combustion. A high level of carbon monoxide concentration may be an early indicator of a combustion event within the treatment chamber 158. The high level of carbon monoxide concentration may also indicate incomplete and/or inefficient combustion of hydrocarbons. The high level of carbon monoxide concentration may be at least 250 ppm, such as 325 ppm, 500 ppm, or higher. Thus, when carbon monoxide concentration within a treatment chamber 158—measured at the treatment chamber 158 and/or the post-treatment gas exit pathway 162—begins to escalate, oxygen concentration, hydrocarbon concentration, flow, humidity, and temperature of the pre- and/or post-treatment gas may be lowered or raised to their desirable levels.

Since the ideal operating oxygen concentration range and temperature range of the treatment chamber 158 is 3% to 9% and 800 degrees Fahrenheit to 1,000 degrees Fahrenheit, respectively, desirable ranges of oxygen concentration and temperature may be 0% to 8.99% and 0 degrees Fahrenheit to 999 degrees Fahrenheit, respectively, when carbon monoxide concentration reaches the high level. The lowering of the oxygen concentration and temperature may be progressive towards their desirable levels. The feedback system may lower the oxygen concentration and temperature in small increments, e.g. 0.5% and 50 degree Fahrenheit, respectively, before reaching their desirable levels.

In one or more embodiments, flow, humidity, oxygen, temperature, and/or hydrocarbon concentration of the pre- and/or post-treatment gas may be regulated in the event of escalating or de-escalating carbon monoxide concentration within the treatment chamber 158, measured at the treatment chamber 158 and/or the post-treatment gas exit pathway 162. Oxygen may be regulated through the addition of fresh air and/or from reactions in a thermal oxidizer or any other type of oxidizer such as a catalytic oxidizer. Temperature may be regulated in a similar manner, in addition or alternatively to an adjustment of the heater 100. Flow may be increased to dissipate vapor contaminants to avert a combustion event and/or to achieve an optimum efficiency of a desorption rate; humidity may be increased to raise moisture content within the treatment chamber 158 to avert a combustion event, or lowered to increase efficiency of the desorption rate; and hydrocarbon concentration may be increased or decreased through an adjustment of the flow of the post-treatment gas.

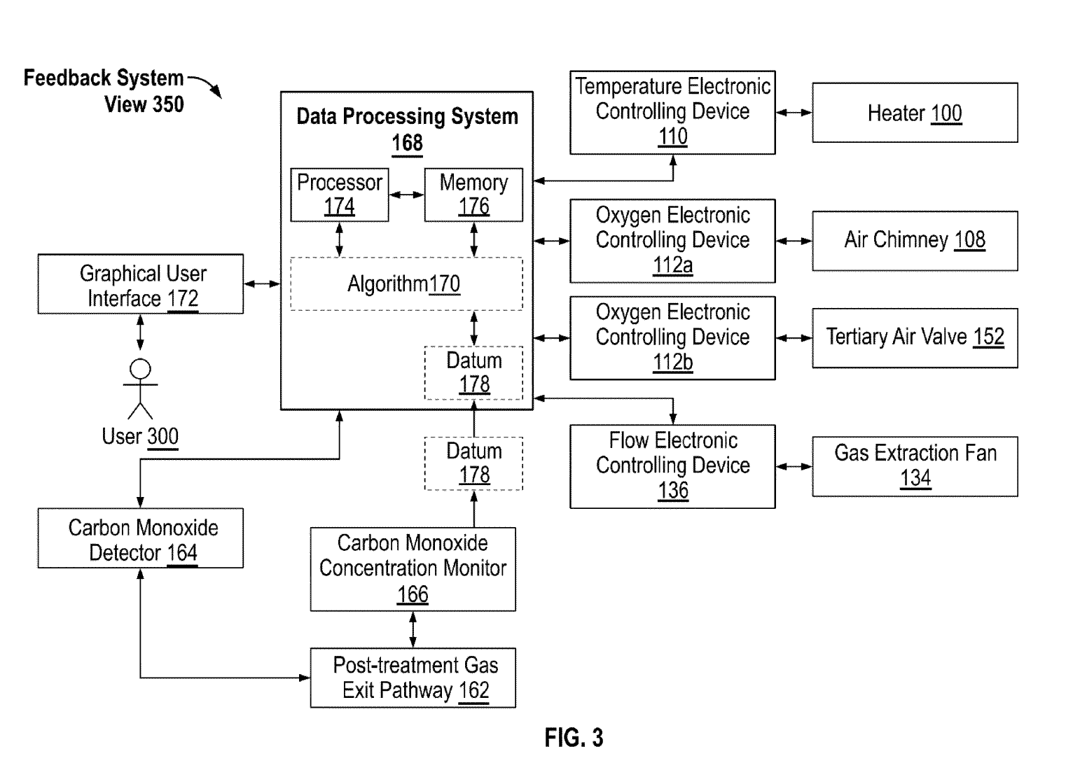

FIG. 3 illustrates the connections of the data processing system 168 from FIG. 1 to various apparatuses for controlling corresponding parameters in the feedback system, according to one or more embodiments.

Particularly, FIG. 3 shows a feedback system view 350, according to one or more embodiments. An embodiment of FIG. 3 describes the heater 100 from FIG. 1, the air chimney 108 from FIG. 1, the temperature electronic controlling device 110 from FIG. 1, the first oxygen electronic controlling device 112a from FIG. 1, the second oxygen electronic controlling device 112b from FIG. 1, the gas extraction fan 134 from FIG. 1, the flow electronic controlling device 136 from FIG. 1, the tertiary air valve 152 from FIG. 1, the post-treatment gas exit pathway 162 from FIG. 1, the carbon monoxide detector 164 from FIG. 1, the carbon monoxide concentration monitor 166 from FIG. 1, the algorithm 170 from FIG. 1, the graphical user interface 172 of FIG. 1, the processor 174 from FIG. 1, the memory 176 from FIG. 1, the datum 178 from FIG. 1, and introduces a user 300.

The data processing system 168 may comprise the processor 174, the memory 176, the algorithm 170, and at least one datum 178 inputted from the carbon monoxide concentration monitor 166. The algorithm 170 may compute process inputs of treatment parameters to avert a combustion event within the treatment chamber 158 from FIG. 1 and/or to achieve an optimum efficiency of a desorption rate. The feedback system may then feedback the inputs to the various electronic controlling devices to control corresponding apparatuses.

In one or more embodiments, the data processing system 168 may be communicatively coupled to: the temperature electronic controlling device 110, which may control the heater 100 used to heat the pre-treatment gas; the oxygen electronic controlling device 112a, which may control the air chimney 108 to regulate oxygen concentration of the pre-treatment gas; another oxygen electronic controlling device 112b, which may control the tertiary air valve 152 to regulate oxygen concentration of the post-treatment gas; and the flow electronic controlling device 136, which may control the gas extraction fan 134 to regulate flow.

The data processing system 168 may also be communicatively coupled to: the carbon monoxide concentration monitor 166, which may monitor carbon monoxide concentration at the treatment chamber 158 and/or the post-treatment gas exit pathway 162; the carbon monoxide detector 164, which may detect the presence of carbon monoxide at the treatment chamber 158 and/or the post-treatment gas exit pathway 162; and the graphical user interface 172, which may display input data and output data to the user 300.

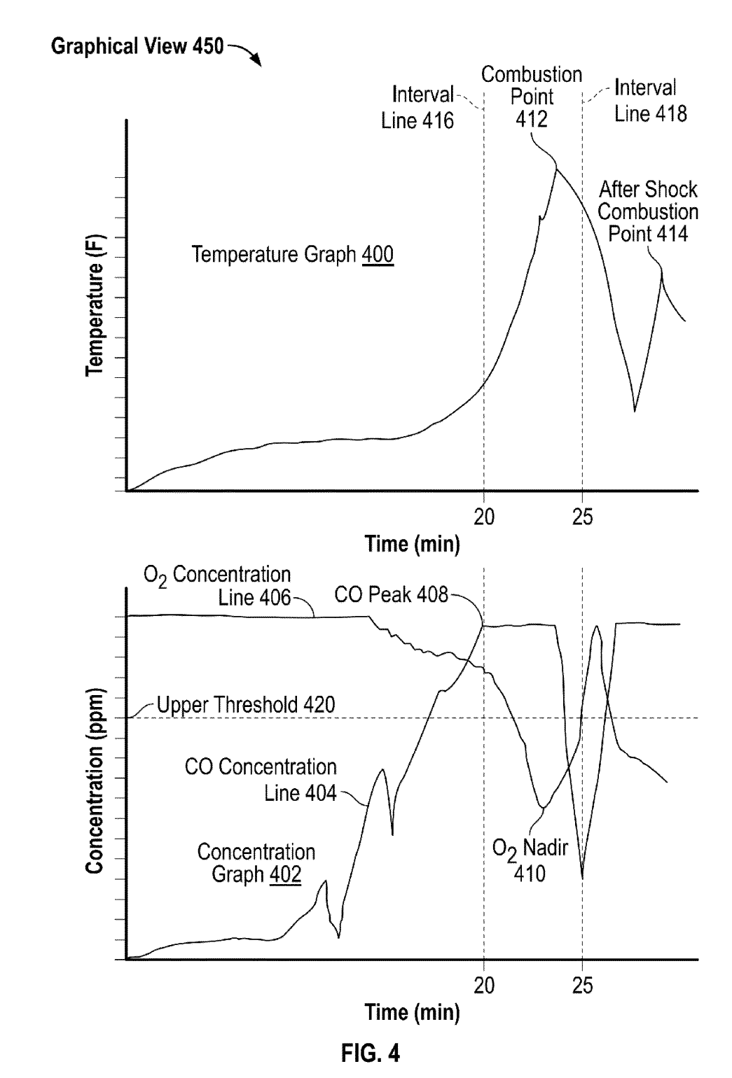

FIG. 4 is a graphical view of the relationships between carbon monoxide concentration, oxygen concentration and combustion, according to one or more embodiments.

illustrates an expansive view 150

Particularly, FIG. 4 illustrates graphical view 450 that introduces a temperature graph 400, a concentration graph 402, a CO concentration line 404, an O2 concentration line 406, a CO peak 408, an O2 nadir 410, a combustion point 412, an aftershock combustion point 414, an interval line 416, and an interval line 418.

In the temperature graph 400, temperature of the treatment chamber 158 from FIG. 1 is plotted against time. At approximately 20 minutes into a thermal desorption process, the temperature rises exponentially until it reaches the combustion point 412, which is representative of a combustion event. Immediately following the combustion event, temperature drops dramatically until a second combustion event occurs at the aftershock combustion point 414.

The concentration graph 402 shows the relationship between oxygen concentration and carbon monoxide concentration within the treatment chamber 158 during a thermal desorption process. At approximately 15 minutes, carbon monoxide concentration begins to climb as oxygen concentration begins to fall. The progressive lowering of oxygen concentration may be explained by small combustion events occurring within the treatment chamber 158, which consumes oxygen gas molecules. This inverse relationship between carbon monoxide concentration and oxygen concentration is seen throughout the graph, and especially at the CO peak 408, where carbon monoxide concentration is at its zenith and oxygen concentration dramatically slopes downward until reaching the O2 nadir 410, where oxygen concentration is at its lowest.

Using interval line 416 and interval line 418 to compare carbon monoxide concentration with temperature of the treatment chamber 158, it is evident that carbon monoxide is an excellent indicator of combustion within a treatment chamber 158. At the first reference interval line 416, at approximately 20 minutes into a process on a soil batch, carbon monoxide concentration peaks and the combustion point 412 from the temperature graph 400 quickly follows thereafter, indicating that a combustion event has occurred. At the second reference interval line 418, carbon monoxide concentration significantly dips as temperature within the treatment chamber 158 quickly follows. Momentarily after the second reference line, carbon monoxide concentration begins to climb again as the temperature graph 400 reaches the aftershock combustion point 414 thereafter, indicative of a second combustion event.

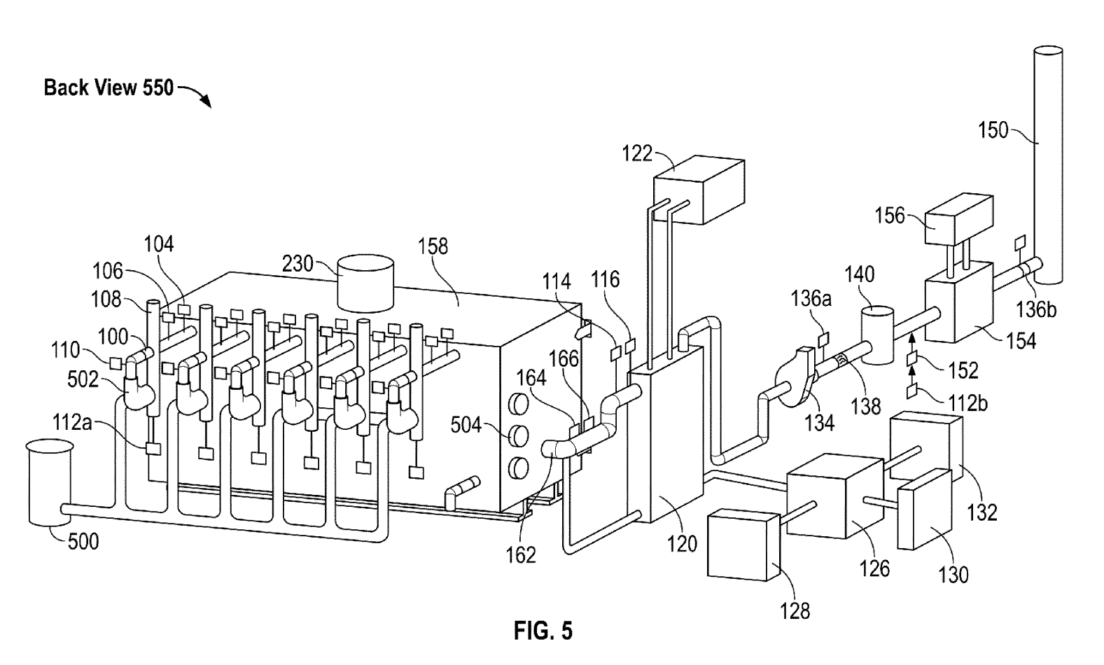

FIG. 5 is an expansive back view of a thermal desorption soil reclamation and remediation system, according to one or more embodiments.

Particularly, FIG. 5 illustrates an expansive view 550, according to one or more embodiments. The embodiments of FIG. 5 describes the heater 100 from FIG. 1, the inlet temperature sensor 104 from FIG. 1, the inlet oxygen sensor 106 from FIG. 1, the air chimney 108 from FIG. 1, the temperature electronic controlling device 110 from FIG. 1, the oxygen electronic controlling device 112a from FIG. 1, the oxygen electronic controlling device 112b from FIG. 1, the outlet oxygen sensor 114 from FIG. 1, the outlet temperature sensor 116 from FIG. 1, the heat exchanger I 120 from FIG. 1, the heat exchanger cooler I 122 from FIG. 1, the phase separator 126 from FIG. 1, the heavy contaminants tank 128 from FIG. 1, the water or liquid tank 130 from FIG. 1, the light contaminants tank 132 from FIG. 1, the gas extraction fan 134 from FIG. 1, the flow electronic controlling device 136a from FIG. 1, the flow electronic controlling device 136b from FIG. 1, the flame arrester 138 from FIG. 1, the thermal oxidizer 140 from FIG. 1, the stack 150 from FIG. 1, the tertiary air valve 152 from FIG. 1, the heat exchanger II 154 from FIG. 1, the heat exchanger cooler II 156 from FIG. 1, the treatment chamber 158 from FIG. 1, the post-treatment gas exit pathway 162 from FIG. 1, the carbon monoxide detector 164 from FIG. 1, the carbon monoxide concentration monitor 166 from FIG. 1, the explosion relief vent 230 from FIG. 2, and introduces a desiccant unit 500, a heater blower 502, and a gas exit pathway penetration 504.

One or more soil box 180 may be placed in the treatment chamber 158. The treatment chamber 158 may be insulated to prevent heat loss. The soil box 180 may be open on top and may comprise the post-treatment gas exit pathway 162. The soil box 180 may be filled with the contaminated soil 182, and may then be installed in the treatment chamber 158 for contamination treatment, and may be removed after the contamination treatment is complete. The soil box 180 may provide for a batch process for contaminated soil 182. Pre-treatment gas may be introduced to the treatment chamber 158 through the pre-treatment gas inlet 160. The pre-treatment gas may be heated, desiccated, and/or inerted. The pre-treatment gas may pass through the contaminated soil 182 in the soil box 180 to the post-treatment gas exit pathway 162, and then flow out of the treatment chamber 158. The process brings pre-treatment gas into the treatment chamber 158. The pre-treatment gas then has a flow path through the contaminated soil 182 in the soil box 180 to the post-treatment gas exit pathway 162 that provides a flow path out of the treatment chamber 158 for post-treatment gas and contaminants from the treatment chamber 158.

In one or more embodiments, the pre-treatment gas can have controlled humidity for optimizing the treatment process. A wet soil may accept a low humidity treatment, e.g. dry gas, while a dry soil can accept higher humidity treatment gas, e.g. wetter gas.

The resultant post-treatment gas may comprise condensable hydrocarbon contaminants and/or non-condensable hydrocarbon contaminants, which may be recovered. A recovering assembly may be coupled to the post-treatment gas exit pathway 162 to recover all or a portion of the hydrocarbon contaminants in the post-treatment gas. The recovering assembly may comprise heat exchanger I 120, its associated heat exchanger cooler I 122, which may provide cooling fluid (e.g. water, glycol, and etc.) to the heat exchanger I 120; and the gas extraction fan 134, which may provide the flow of post-treatment gas from the treatment chamber 158 through the heat exchanger I 120. The cooling in the heat exchanger I 120 condenses condensable hydrocarbon contaminants and the resultant condensate is directed to an outlet that flows to the phase separator 126. Heavy contaminants, light contaminants, and water or liquids are separated in the phase separator 126 and flow through outlets to heavy contaminants tank 128, light contaminants tank 132, and water or liquid tank 130. The remaining residues may be exhausted to a vent stack 150, and the recovered condensate may be further processed.

In one or more embodiment, the back side of the chamber may have penetrations for discharge from the multiple heater blower 502. The process may begin with fresh air drawn through the desiccant unit 500 by the heater blower 502 to provide fresh dry air. The evaporative desorption soil treatment unit may be transported to the site of the soil contamination where the treatment chamber is installed in a location convenient to the excavation site. The desiccant unit 500 may be piped to the suction of the heater blower 502. The soil treatment may be started by establishing air through the treatment chamber. The gas extraction fan 134 may be turned on to establish air flow. The air may flow through the desiccant unit 500 into the heater blower 502 and into the treatment chamber 158. When the air leaving the treatment chamber 158 has reached the desired temperature, the soil treatment may be completed and the heater 100 may be turned off.

In one or more embodiment, the temperature of the exhaust gas may be measured at the gas exit pathway penetration 504 as a process control. If an internal vapor treatment system is used, the temperature may be measured before passage through the vapor treatment system. The temperature required to remove contaminants may be dependent on the contaminant and the type of soil involved and may be determined on a case-by-case basis for each site. Alternatively, the exhaust gas may be sampled for the contaminant of interest to determine the state of decontamination of the soil being treated.

The heater 100 may be configured to heat pre-treatment gas prior to injection into the treatment chamber 158. The heater 100 may be coupled with a desiccant unit 500 to lower the humidity of the pre-treatment gas and/or a blower to flow the pre-treatment gas into the treatment chamber 158. The desiccant unit 500 may be placed prior to or after the blower unit. By lowering the humidity of the pre-treatment gas to below 10% or below 5% humidity level, significantly faster and more efficient desorption of the contaminants can be achieved. The gas extraction fan 134 may discharge the mixture of post-treatment gas comprising condensable hydrocarbon contaminants, and/or non-condensable hydrocarbon contaminants through flame arrester 138, and then to the thermal oxidizer 140. The concentrations of non-condensed condensable hydrocarbon contaminants and/or non-condensable hydrocarbon contaminants affect fuel consumption in the thermal oxidizer 140. Higher concentrations of non-condensed condensable hydrocarbon contaminants are generally encountered in the latter stages of a treatment cycle on a batch. In the earlier stages of treatment, the cooling at heat exchanger I 120 may be adjusted to provide additional non-condensed condensable hydrocarbon contaminants as extra fuel to the thermal oxidizer 140 to minimize supply fuel addition to the process. The residual hydrocarbon contaminants in the resultant post-treatment gas may be destroyed in the thermal oxidizer 140 by the addition of secondary air to the treatment gas, and then a mixture of combustion air and fuel (e.g. natural gas, propane, and etc.) in the thermal oxidizer 140. Alternatively, electric energy heating in the thermal oxidizer 140 may be used in place of the energy of fuel combustion, or as a supplement. A flameless thermal oxidizer 140 may facilitate use of the invention in locations that preclude combustion equipment, such as on an offshore oil rig or the like. In addition to purification by destruction of the hydrocarbon contaminants in the post-treatment gas by the thermal oxidizer 140, it may also remove remaining oxygen gas. The discharge post-treatment gas from the thermal oxidizer 140 may flow to heat exchanger II 154, which may comprise an adjustable cooling fluid from the associated heat exchanger cooler II 156. This discharge is conditioned for recycle as pre-treatment gas by the addition of tertiary air controlled by the tertiary air valve 152. The tertiary air addition is controlled to maintain the desired inert oxygen concentration in the pre-treatment gas for any purpose such as to control auto-ignition or to provide any alteration such as for pyrolysis. Typically, the range of 3% to 9% may be required to maintain the oxygen concentration outside the explosive envelope for contaminants in the treated soil, and may provide sufficient oxygen for reaction with the contaminants. The cooling by heat exchanger II 154 is controlled to maintain the desired temperature of the pre-treatment gas going into the treatment chamber 158. The discharge from heat exchanger I 154 may be split and the desired flow may be used as pre-treatment gas to the treatment chamber 158. The flow electronic controlling device 136b may maintain the desired flow. The balance may flow to the stack 150, which may then discharge to the environment. Process control may be aided by measurement of the pre-treatment gas oxygen content by the inlet oxygen sensor 106, the pre-treatment gas temperature by the inlet temperature sensor 104, post-treatment gas oxygen content by the outlet oxygen sensor 114, and the post-treatment gas temperature by the outlet temperature sensor 116. Other instruments may be used for monitoring and control of the individual components of the process. The nitrogen supply 184 may be provided to the insulated treatment chamber 158 for use in startup and in case the oxygen content of the pre-treatment gas is higher than the desired value.

In one or more embodiments, systems and methods may be provided to regulate pre-treatment gas, e.g. temperature and flow rate, to the treatment chamber 158. The regulation may be based on time, on data from previous processes, or on measured temperature of the post-treatment gas of the treatment chamber 158. The outlet temperature sensor 116 may be placed at or near the post-treatment gas exit pathway 162 to measure the temperature of the post-treatment gas that exits the treatment chamber 158. The outlet temperature sensor 116 (and the inlet temperature sensor 106) may be a thermocouple. The measured temperature may be used by the algorithm 170 of memory 176 coupled to the processor 174 of the data processing system 168 to control a thermal energy input to the treatment chamber 158, e.g., by regulating the heater 100 that heats the pre-treatment gas or regulate the blower that controls the flow of the pre-treatment gas. The contaminants can include different types of hydrocarbons, so a temperature between 250 F and 150 F, such as 212 F, may be used to change the flow rate or the temperature of the pre-treatment gas. The outlet temperature sensor 116 may be placed at the post-treatment gas exit pathway 162, such as at or near the exit of the treatment chamber 158. A feedback may be provided to a data processing system 168, which may be configured to control or regulate the blower, desiccant unit, and/or the heater 100.

The desiccant unit may be optionally used to lower the humidity of the pre-treatment gas. The blower may be configured to provide a desired flow rate of pre-treatment gas to the treatment chamber 158. The heater 100 may be configured to heat the pre-treatment gas for providing a dry, hot pre-treatment gas to the treatment chamber 158.

The feedback may be used to regulated, e.g., increasing or decreasing a thermal energy provided to heat the pre-treatment gas. For example, at the beginning of a treatment cycle, the post-treatment gas temperature at the outlet temperature sensor 116 may be low, and the heater 100 may be turned on to heat the pre-treatment gas. When the post-treatment gas temperature exceeds a predetermined threshold temperature, thermal energy from the heater 100 may be reduced or turned off. The predetermined threshold temperature may be set before a treatment cycle, e.g., by assessing the characteristics of the contaminated soil 182 from a sample treatment run. The predetermined threshold temperature may be determined from previous runs, e.g., by continuously collecting the characteristics of the contaminated soil 182 in previous batches. In general, a predetermined threshold temperature between 100 F to 300 F, 150 F to 250 F, or 220 F to 230 F may be used. In one or more embodiments, a thermal desorption process with improved safety may be provided. At temperatures below the auto-ignition temperature of hydrocarbons (which is about 400 F for hydrocarbon chains n-CxHy with x>8, and about 500 F for x>5), the conveyance of post-treatment gas, which is carrying the hydrocarbon contaminants, may have minimum explosion hazard. Thus in one or more embodiments, special considerations are provided in a conduit section until the post-treatment gas temperature is reduced to below the auto-ignition temperature. Alternatively, the post-treatment gas temperature may be limited to below the auto-ignition temperature as soon as it exits the treatment chamber 158.

In one or more embodiments, systems and methods may be provided to regulate a temperature of the post-treatment gas of the treatment chamber 158 to reduce or prevent potential explosion hazards. The outlet temperature sensor 116, such as a thermocouple, may be placed at or near the post-treatment gas exit pathway 162 of the treatment chamber 158 to measure the temperature of the post-treatment gas that exits the treatment chamber 158. The measured temperature may be used by the algorithm 170 of memory 176 coupled to the processor 174 of the data processing system 168 to control a thermal energy input to the treatment chamber 158, e.g., by regulating the heater 100 that heats the pre-treatment gas. The contaminants may include different types of hydrocarbons with different auto-ignition temperatures, so a reasonable upper end temperature of 500 F or 400 F may be used to limit the temperature of the post-treatment gas.

In one or more embodiments, input temperature regulation may be reflected in the post-treatment gas temperature, measured by the outlet temperature sensor 116. For example, heater 100 may be used to heat the pre-treatment gas. The heater 100 may be controlled through a variable frequency drive assembly that will automatically adjust heat delivery based on a temperature feedback from the post-treatment gas. Limiting the temperature of the post-treatment gas to, e.g., 400 F may reduce the temperature below an auto-ignition temperature. Bench studies show significant hydrocarbon vapor production with post-treatment gas temperature of 400 F. Redundant thermocouples placed at the soil box 180 exit may be set at the predetermined threshold temperature setting. Within the soil bed, temperatures may exceed 400 F; however, the pre-treatment gas is contained within the soil and subsequently cooled between the moving oxidation front and the post-treatment gas exit pathway 162. The vapors are in porous flow conditions, which acts similar to a spark or flame arrestor. The vapor pathways are non-linear, which will not propagate a spark or flame.

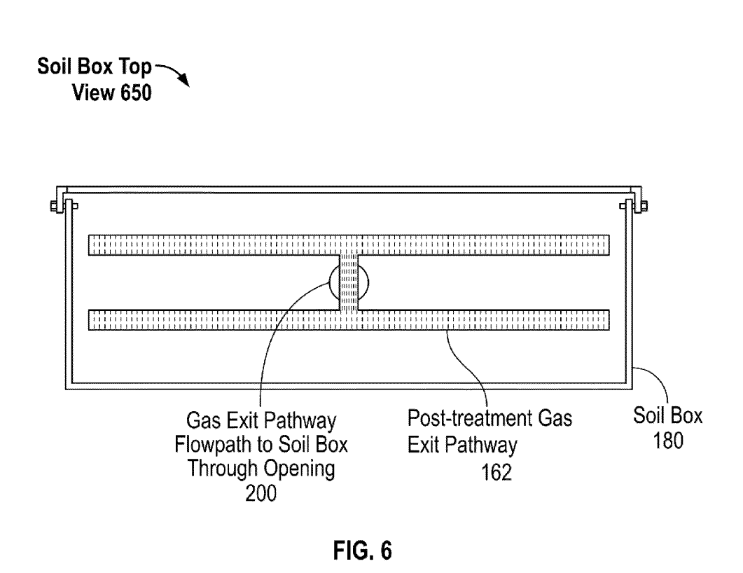

FIG. 6 is a top view 650 of the soil box showing the arrangement of the post-treatment gas exit pathway of FIG. 1, according to one or more embodiments.

In one or more embodiment, FIG. 6 describes the soil box 180 from FIG. 1, the post-treatment gas exit pathway 162 from FIG. 1, and the gas exit pathway flow path to soil box through opening 200 from FIG. 1.

In one or more embodiment, the insulated treatment chamber 158 from FIG. 1 may have a soil box 180 installed. The treatment chamber may be insulated. The soil box 180 may contain a gas exit pathway 162 located near the bottom of the box. Gas exit pathway 162 may be perforated to allow flow of treatment gas from the surrounding soil into the pathway. The soil box 180 may be installed on a pedestal soil box support 220 from FIG. 1 that provides a flow path from the soil box gas exit pathway 162 to provide for treatment gas and contaminants from the treatment chamber 158 to exit the chamber.

The pedestal soil box support 220 also may provide for ease of installation and removal of the soil box 180 from the insulated treatment chamber 158. The gas exit pathway 162 provides a flow path from the pathway to the gas exit pathway flow path to soil box through opening 200 in the bottom of the soil box 180. This opening 200 may arranged to be located over the pedestal soil box support 220 that also has a compatible opening. The connection of the gas exit pathway 162 to the treatment gas and contaminants from the treatment chamber 158 is simply to install the soil box 180 into the insulated treatment chamber 158.

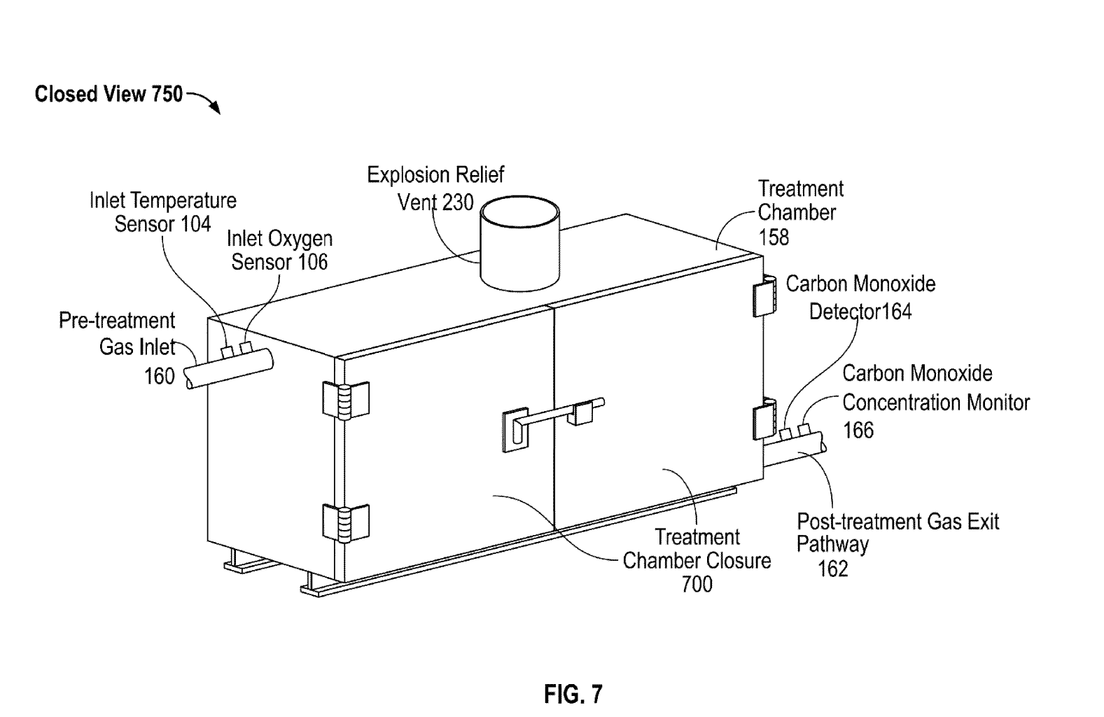

FIG. 7 is a perspective view of the treatment chamber of FIG. 1, according to one or more embodiments.

Particularly, FIG. 7 illustrates a closed view 750 showing the arrangement of an embodiment of the treatment chamber from the chamber closure side of the chamber.

In one or more embodiment, FIG. 7 shows the insulated treatment chamber 158 with a treatment chamber closure 700 that may be insulated in the closed position.

The insulated treatment chamber 158 may have a soil box 180 installed. The chamber may be insulated. The soil box 180 may contain a gas exit pathway 162 located near the bottom of the box. The post-treatment gas exit pathway 162 is shown. This pathway 162 may be perforated to allow flow of treatment gas from the surrounding soil into the pathway. The soil box 180 may be installed on a pedestal soil box support 220 that provides a flow path from the soil box gas exit pathway 162 to provide for treatment gas and contaminants from the treatment chamber 158 to exit the chamber.

The pedestal soil box support 220 also may provide for ease of installation and removal of the soil box 180 from the insulated treatment chamber 158. The post-treatment gas exit pathway 162 may provide a flow path from the pathway to an opening in the bottom of the soil box 180. This opening may be arranged to be located over the pedestal soil box support 220 that also has a compatible opening. The connection of the gas exit pathway 162 to the treatment gas and contaminants from the treatment chamber 158 may be simply to install the soil box 180 into the insulated treatment chamber 158.

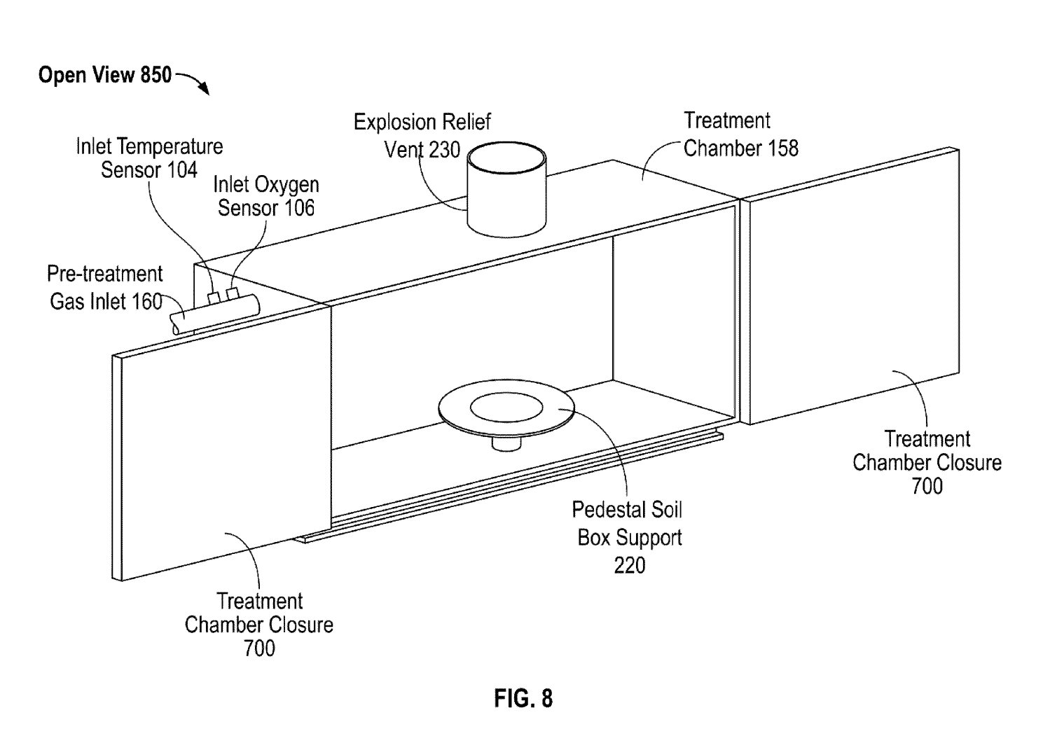

FIG. 8 is a perspective view of the treatment chamber of FIG. 1, according to one or more embodiments.

Particularly, FIG. 8 illustrates an open view 850 showing the arrangement of an embodiment of the treatment chamber from the chamber closure side of the chamber with the chamber closure open showing the pedestal treatment vessel support.

In one or more embodiment, the insulated treatment chamber closure 700 from FIG. 7 may be in an open position. The soil box 180 in the open position is easily installed or removed. Once installed, the weight of the contained soil provides a sufficient seal at the contact between the soil box bottom and the pedestal soil box support. An explosion relief vent 230 from FIG. 2 may provide for venting of the pressurized content of the treatment chamber 158 from FIG. 1 in the event of rapid pressure increase. The relief vent 230 directs the expelled gasses upward. This opening is arranged to be located over the pedestal soil box support 220 from FIG. 2, which may comprise a compatible opening. An explosion relief vent 230 may provide for venting of the pressurized content of the treatment chamber 158 in the event of rapid pressure increase. The relief vent 230 directs the expelled gasses upward.

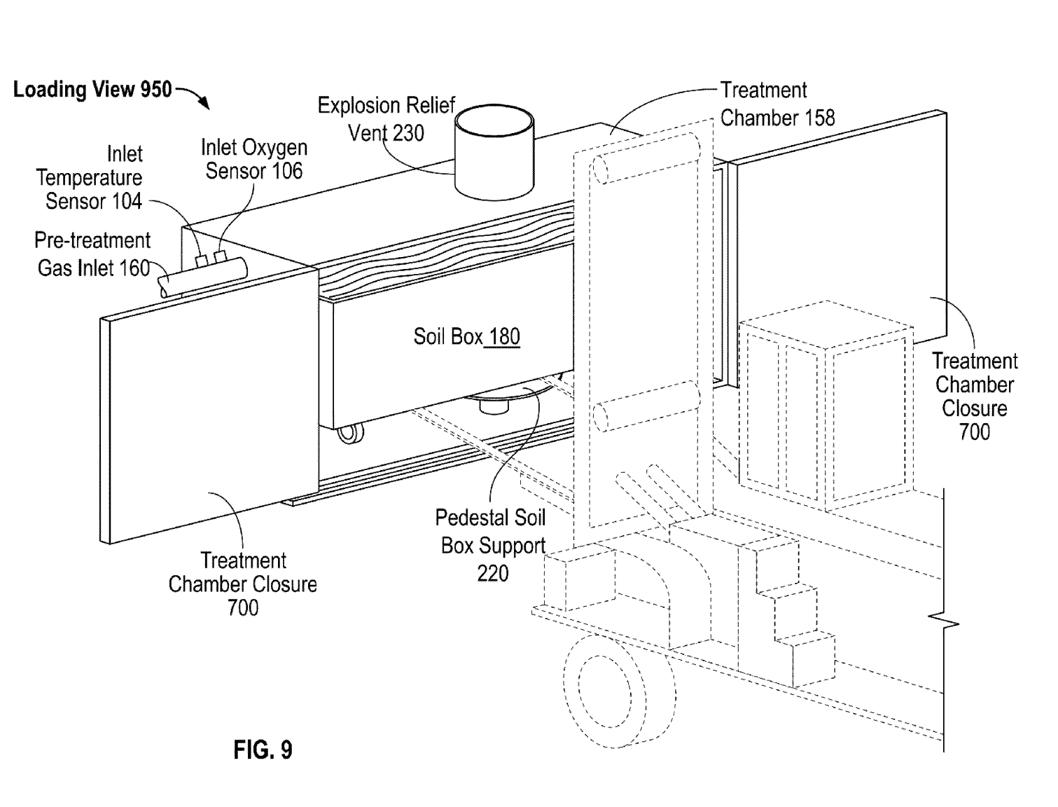

FIG. 9 is a perspective view of the treatment chamber of FIG. 1, according to one or more embodiments.

Particularly, FIG. 9 illustrates a loading view 950 showing the arrangement of an embodiment of the treatment chamber from the chamber closure side of the chamber with the chamber closure open showing a soil box being installed on the pedestal treatment vessel support.

The pedestal soil box support 220 may provide for ease of installation and removal of the soil box 180 from the treatment chamber 158 as shown in FIG. 9. The post-treatment gas exit pathway 162 may provide a flow path from the pathway to an opening located at the bottom of the soil box 180.

The insulated treatment chamber 158 may be installed the soil box 180. The soil box 180 may contain a gas exit pathway 162 located near the bottom of the box. This pathway 162 may be perforated to allow flow of treatment gas from the surrounding soil into the pathway. The soil box 180 may be installed on a pedestal soil box support 220 that may provide a flow path from the soil box gas exit pathway 162 to provide for treatment gas and contaminants from the treatment chamber 158 to exit the chamber.

The gas exit pathway 162 as shown may provide a flow path from the pathway to an opening in the bottom of the soil box 180. This opening may be arranged to be located over the pedestal soil box support 220 that also has a compatible opening. The connection of the gas exit pathway 162 to the treatment gas and contaminants from the treatment chamber 158 may be simply to install the soil box 180 into the insulated treatment chamber 158.

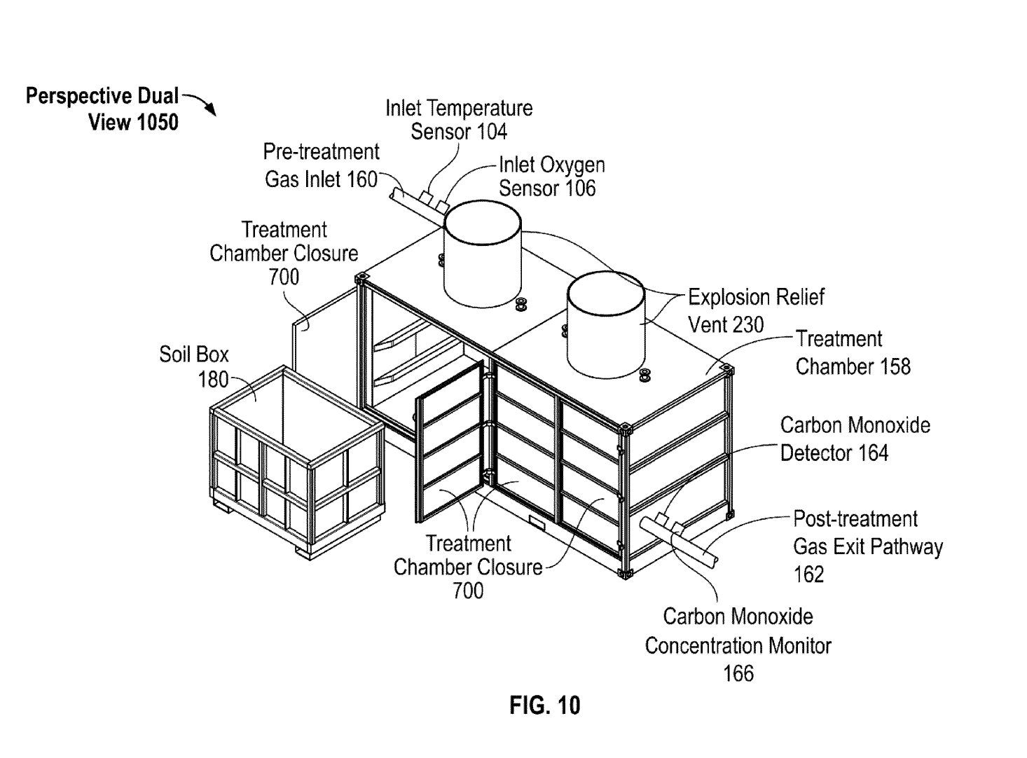

FIG. 10 is a perspective view showing another embodiment of the treatment chamber using dual soil boxes.

Particularly, FIG. 10 illustrates a perspective dual view 1050 of the treatment chamber of FIG. 1 showing two dual treatment areas integrated into a single treatment chamber, according to one or more embodiments.

FIG. 10 shows another embodiment of the treatment chamber 158 and soil box 180 using dual treatment areas integrated into a single treatment chamber. The embodiment may include separate chamber closures 700 for each treatment area, and separate pedestal soil box supports 220 for each area.

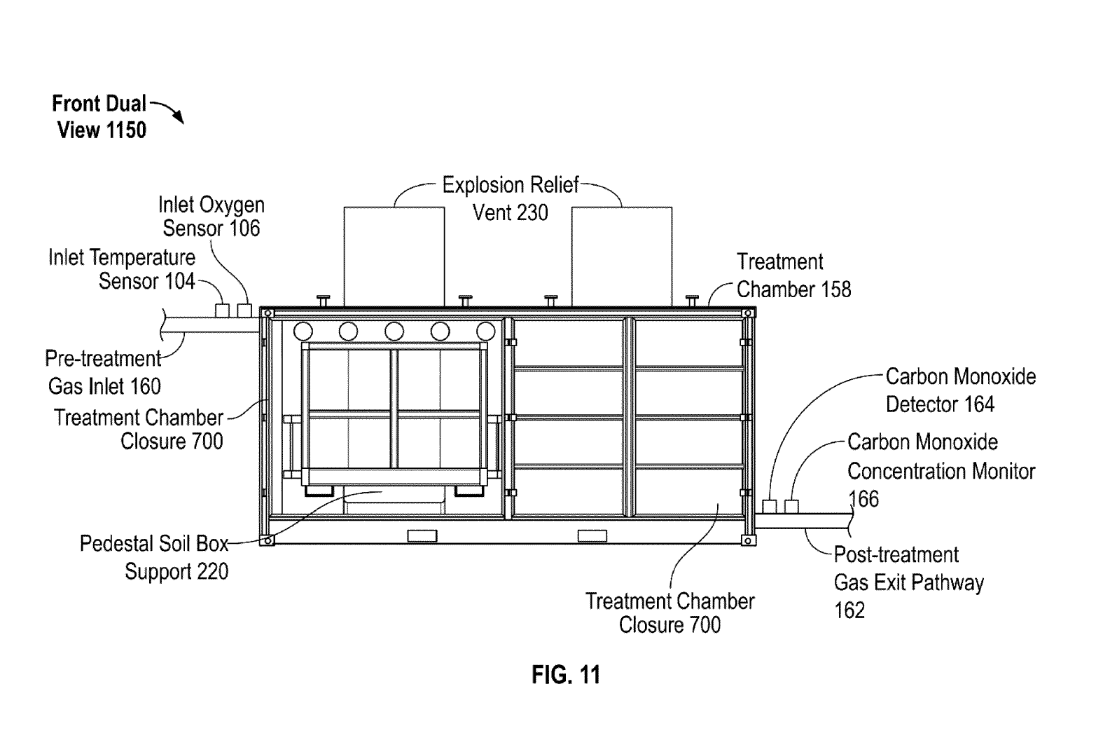

FIG. 11 is a shows a second embodiment of the treatment chamber of FIG. 1 showing two connected treatment chambers, according to one or more embodiments.

Particularly, FIG. 11 illustrates a front dual view 1150 showing the treatment chamber 158 and soil box 180 using dual treatment areas integrated into a single treatment chamber. The embodiment may include separate chamber closures 700 for each treatment area, and separate pedestal soil box supports 220 for each area.

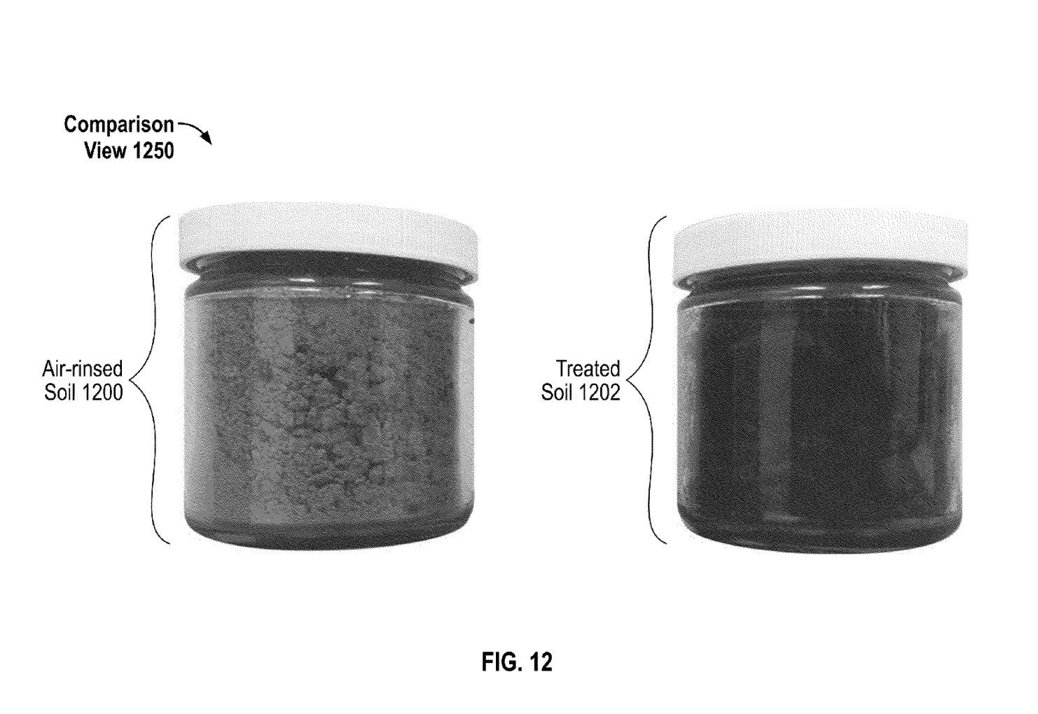

FIG. 12 is a comparison view 1250 of air-rinsed soil and treated soil, according to one or more embodiments.

Particularly, FIG. 12 introduces an air-rinsed soil 1200, and a treated soil 1202. In one or more embodiments, treated soil 1202 may be a soil sample of a contaminated soil 182 batch that have been subjected to a thermal desorption process. Treated soil 1202 may comprise a dark coloration, indicating the process of tar and/or residual hydrocarbon contaminants that were not removed through the system. A fresh air rinse may permit the treated soil 1202 to oxidize the residual hydrocarbon contaminants through an inlet of 21% oxygen fresh air, and utilizing the residual heat within the treatment chamber 158 after a batch run. The resultant air-rinsed soil 1200 may comprise a lighter coloration than that of the treated soil 1202. The resultant air-rinsed soil 1200 may be returned to an excavation site.

In one or more embodiments, the fresh air rinse may be less or more than the 21% oxygen found in atmospheric fresh air. The fresh air rinse may be of higher concentration of oxygen or lower concentration of oxygen relative to the 21% oxygen concentration of fresh air. A determination to use higher or lower concentration of oxygen for the fresh air rinse may be made based on data from a soil sample, e.g., from treated soil 1202. The treated soil 1202 may comprise a highly volatile hydrocarbon contaminant and may require a fresh air rinse of less than 21% oxygen concentration, e.g., such as 15% oxygen concentration, to avoid combustion of the highly volatile hydrocarbon contaminant due to oxidation. On the other hand, the treated soil 1202 may comprise less volatile hydrocarbon contaminants and may require a fresh air rinse of more than 21% oxygen concentration, e.g., such as from an oxygen tank, in order to fully oxidize the residual hydrocarbon contaminants, and to return the coloration of the treated soil 1202 to that similar to the air-rinsed soil 1200.

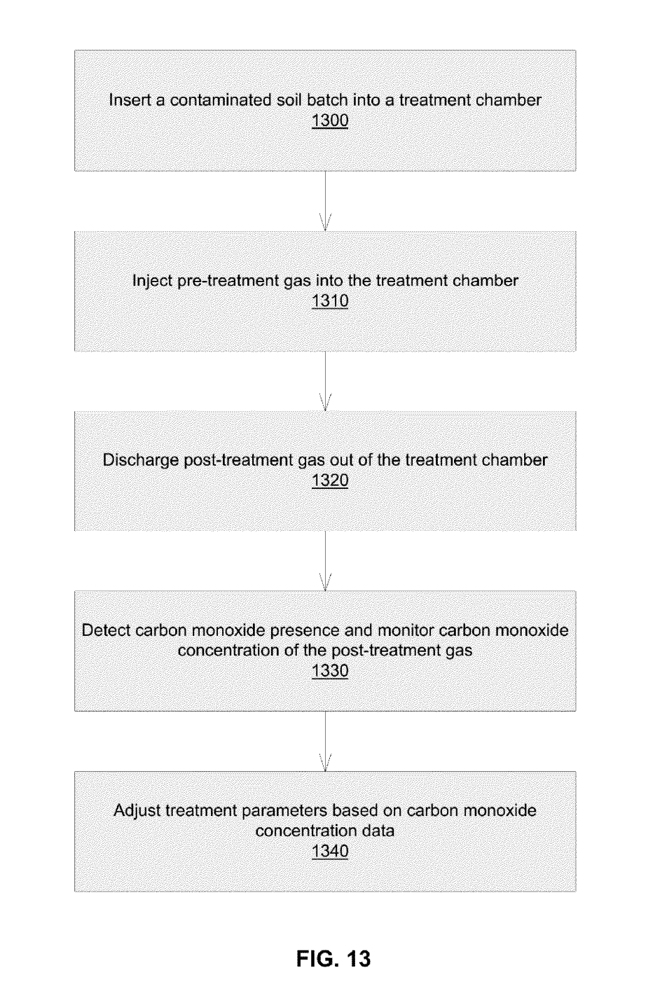

FIG. 13 is a flow diagram of a thermal desorption process, according to one or more embodiments.

FIG. 13 is a flowchart for a thermal desorption process, according to one or more embodiments. Operation 1300 may insert a contaminated soil 182 batch into a treatment chamber 158. The treatment chamber 158 may be insulated. In operation 1310, pre-treatment gas may be injected into the treatment chamber 158. The pre-treatment gas may be heated and/or inerted prior to injection into the treatment chamber 158 for desorbing contaminants from the soil batch. Operation 1320 may discharge post-treatment gas out of the treatment chamber 158 after the treatment process. The post-treatment gas may comprise condensable hydrocarbon contaminants and/or non-condensable hydrocarbon contaminants. Operation 1330 may detect carbon monoxide presence and monitors carbon monoxide concentration of the post-treatment gas after the post-treatment gas leaves the treatment chamber 158, preferably at the post-treatment gas exit pathway 162; however, the detecting of carbon monoxide presence and monitoring of the carbon monoxide concentration may be conducted at any point in the system after the post-treatment gas exits the treatment chamber 158 and/or at the treatment chamber 158. In operation 1340, treatment parameters may be adjusted based on carbon monoxide concentration data from the carbon monoxide concentration monitor 166. The treatment parameters may comprise pre-treatment gas oxygen concentration, pre-treatment gas hydrocarbon concentration, pre-treatment gas temperature, pre-treatment gas flow, pre-treatment gas humidity, post-treatment gas oxygen concentration, post-treatment gas hydrocarbon concentration, post-treatment gas temperature, post-treatment gas flow, and/or post-treatment gas humidity.

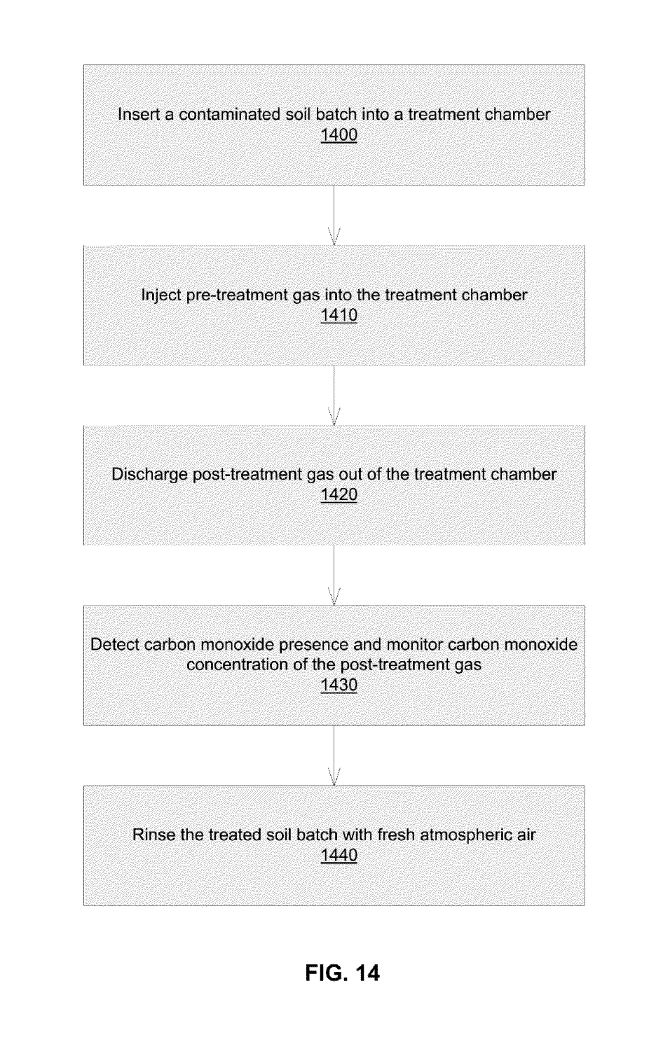

FIG. 14 is a flowchart illustrating an alternative embodiment for a thermal desorption process. In operation 1400, a contaminated soil 182 batch may be inserted into a treatment chamber 158. The treatment chamber 158 may be insulated. Operation 1410 may inject pre-treatment gas into the treatment chamber 158. The pre-treatment gas may be heated and/or inerted prior to injection into the treatment chamber 158 for desorbing contaminants from the soil batch. Operation 1420 may discharge post-treatment gas out of the treatment chamber 158 after the treatment process. The post-treatment gas may comprise condensable hydrocarbon contaminants and/or non-condensable hydrocarbon contaminants. Operation 1430 may detect carbon monoxide presence and monitors carbon monoxide concentration of the post-treatment gas after the post-treatment gas leaves the treatment chamber 158, preferably at the post-treatment gas exit pathway 162; however, the detecting of carbon monoxide presence and monitoring of the carbon monoxide concentration may be conducted at any point in the system after the post-treatment gas exits the treatment chamber 158 and/or at the treatment chamber. In operation 1440, the treated soil 1202 may be rinsed with fresh atmospheric air.

In one or more embodiments, a thermal desorption soil contaminate removal and/or reclamation system is disclosed. Hydrocarbon contaminants from soil batches may be heated with pre-treatment gas in the treatment chamber 158. Post-treatment gas exiting the treatment chamber 158 may comprise condensable hydrocarbon contaminants and/or non-condensable hydrocarbon contaminants. The post-treatment gas may then be processed in a reclamation method, comprising condensing the condensable hydrocarbon contaminants. The remaining non-condensed condensable hydrocarbon contaminants and/or non-condensable hydrocarbon contaminants in the post-treatment gas may then be oxidized in a thermal oxidizer or any other type of oxidizer such as a catalytic oxidizer to recycle as pre-treatment gas and/or used to heat fresh air to be used as pre-treatment gas.

In the earlier stages of treatment on a soil batch, the cooling from the heat exchanger may be adjusted to provide a desired concentration of non-condensed condensable hydrocarbon contaminants that may be used to provide additional fuel to the thermal oxidizer or any other type of oxidizer such as a catalytic oxidizer. However, this adjustment of the cooling of the condensable hydrocarbon contaminants may be performed in any stage of the treatment on a soil batch, depending on the total net concentration of the noncondensed condensable hydrocarbon contaminants and non-condensable hydrocarbon contaminants in the post-treatment gas at a particular stage. In other words, the adjustment of the cooling of the condensable hydrocarbon contaminants in the post-treatment gas may be made in a manner as to provide a desired concentration of non-condensed condensable hydrocarbon contaminants in addition to the non-condensable hydrocarbon contaminants to be used as additional fuel to the thermal oxidizer or any other type of oxidizer such as a catalytic oxidizer to reduce supply fuel consumption in reheating the post-treatment gas and/or in heating fresh air, thereby improving efficiency and lowering cost of operation.

In general, a high temperature cooling setting may yield more non-condensed condensable hydrocarbon contaminants discharging from the heat exchanger. The opposite may also be true. A low temperature cooling setting may yield less non-condensed condensable hydrocarbon contaminants.

In one or more embodiments, the thermal oxidizeror any other type of oxidizer such as a catalytic oxidizer may use the additional fuel to re-heat the post-treatment gas so that it may be recycled as pre-treatment gas. A tertiary air addition through the tertiary air valve 152 may be used to maintain a desired inert oxygen concentration in the pre-treatment, post-treatment or treatment gas that is to be recycled. In an embodiment, the concentration of any gas or substance may be controlled or additional substances may be inerted to provide for recirculation benefits such as reducing auto-ignition or provide for pyrolysis at any point of treatment in any method or apparatus. The typical range of the inert oxygen concentration may be in the 3% to 9% range to maintain the oxygen concentration outside the explosive envelope for contaminants in a soil batch, but also to provide sufficient oxygen for reaction with the contaminants. The post-treatment gas discharge from the addition of tertiary air through the tertiary air valve 152 may flow to a second heat exchanger. Cooling by the second heat exchanger may be controlled to maintain the desired temperature of the post-treatment gas that is to be recycled as pre-treatment gas going back into the treatment chamber 158 at 800 degrees Fahrenheit to 1,000 degrees Fahrenheit.

In an alternative embodiment, the thermal oxidizer or any other type of oxidizer such as a catalytic oxidizer may use the additional fuel to heat fresh air to be used as pre-treatment gas. A fresh air supply may be injected into the post-treatment gas within the oxidizer, which is then heated through the oxidation of the non-condensed condensable hydrocarbon contaminants and/or non-condensable hydrocarbon contaminants. Fresh air may be higher in oxygen concentration than the post-treatment gas. The thermal oxidizer or any other type of oxidizer such as a catalytic oxidizer may oxidize a desired amount of additional fuel, thereby consuming oxygen gas. An oxygen sensor placed at the oxidizer may output oxygen concentration data to the data processing system 168. The algorithm 170 may be used to compute the desired amount of additional fuel to be oxidized by the oxidizer. The consumption of oxygen gas may maintain the inert oxygen concentration at 3% to 9%, which is outside the explosive envelope for contaminants in a soil batch, but also adequate to provide sufficient oxygen for reaction with the contaminants.

In one or more embodiments, depending on the oxygen concentration discharging from the thermal oxidizer or any other type of oxidizer such as a catalytic oxidizer, the tertiary air may be supplied to maintain the desired 3% to 9% concentration. After achieving the desired inert oxygen concentration of the fresh air to be used as pre-treatment gas, the second heat exchanger may be used to cool the fresh air to maintain the desired temperature of the fresh air supply at 800 F to 1,000 F. In any embodiment any characteristic such as the concentration of any substances, the temperature of substances added, the ambient temperature in the device, or the temperature of the materials, may be of any range to provide for reduced auto-ignition, pyrolysis or any other method, treatment or result.

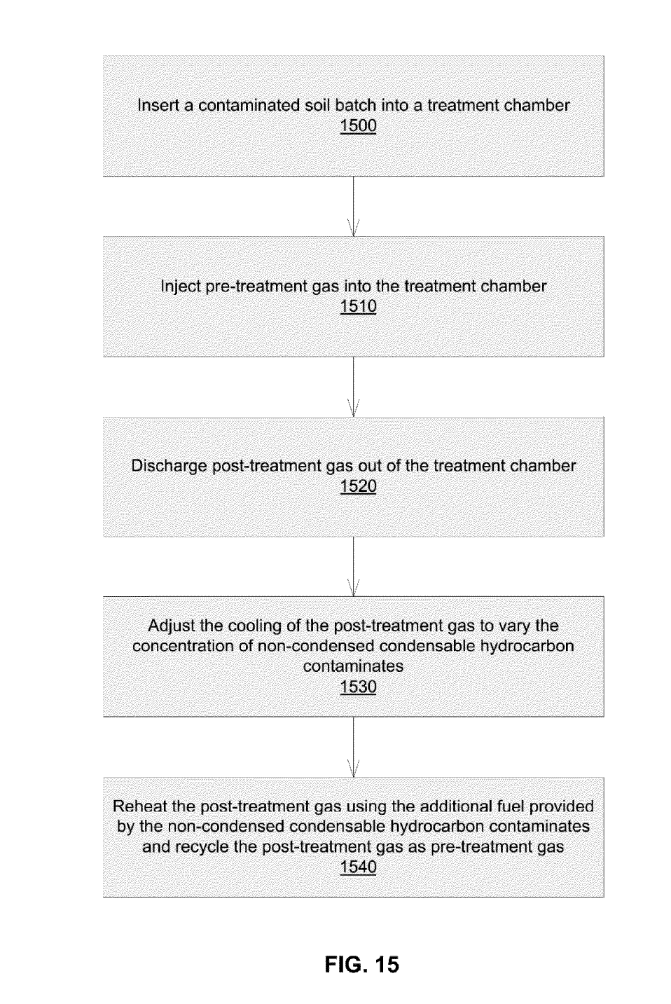

FIG. 15 is a flowchart of a thermal desorption process whereby concentration of noncondensed condensable hydrocarbon contaminants may be adjusted through the adjustment of the cooling of the condensable hydrocarbon contaminants in the post-treatment gas at the heat exchanger, according to one or more embodiments. Operation 1500 inserts a contaminated soil 182 batch into a treatment chamber 158. The treatment chamber 158 may be insulated. In operation 1510, pre-treatment gas is injected into the treatment chamber 158. The pre-treatment gas may be heated and/or inerted prior to injection into the treatment chamber 158 for desorbing contaminants from the soil batch. Operation 1520 discharges post-treatment gas out of the treatment chamber 158 after the treatment process. The post-treatment gas may comprise condensable hydrocarbon contaminants and/or non-condensable hydrocarbon contaminants. Operation 1530 adjusts the cooling of the post-treatment gas to vary the concentration of the noncondensed condensable hydrocarbon contaminants. The adjustment may be made based on the total net concentration of non-condensed condensable hydrocarbon contaminants and noncondensable hydrocarbon contaminants. Operation 1540 reheats the post-treatment gas using the additional fuel provided by the non-condensed condensable hydrocarbon contaminants in addition to the non-condensable hydrocarbon contaminants and recycles the post-treatment gas as pre-treatment gas.

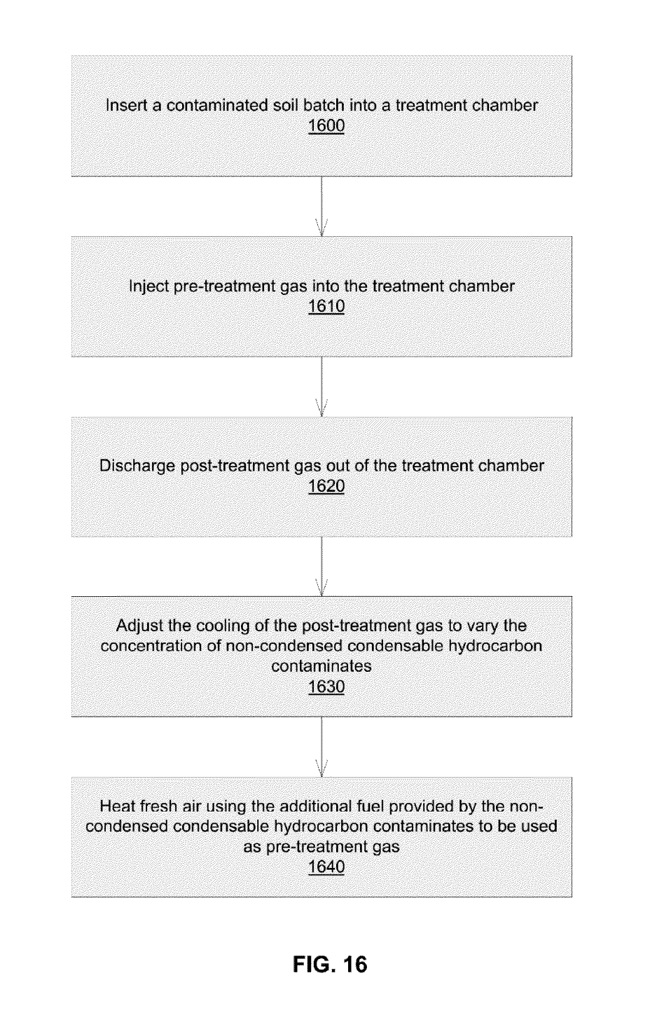

FIG. 16 is a flowchart illustrating an alternative embodiment of a thermal desorption process whereby concentration of non-condensed condensable hydrocarbon contaminants may be adjusted through the adjustment of the cooling of the condensable hydrocarbon contaminants in the post-treatment gas at the heat exchanger, according to one or more embodiments. Operation 1600 inserts a contaminated soil 182 batch into a treatment chamber 158. The treatment chamber 158 may be insulated. In operation 1610, pre-treatment gas is injected into the treatment chamber 158. The pre-treatment gas may be heated and/or inerted prior to injection into the treatment chamber 158 for desorbing contaminants from the soil batch. Operation 1620 discharges post-treatment gas out of the treatment chamber 158 after the treatment process. The post-treatment gas may comprise condensable hydrocarbon contaminants and/or non-condensable hydrocarbon contaminants. Operation 1630 adjusts the cooling of the post-treatment gas to vary the concentration of the non-condensed condensable hydrocarbon contaminants. The adjustment may be made based on the total net concentration of non-condensed condensable hydrocarbon contaminants and non-condensable hydrocarbon contaminants. Operation 1640 heats fresh air using the additional fuel provided by the non-condensed condensable hydrocarbon contaminants in addition to non-condensable hydrocarbon contaminants to be used as pre-treatment gas.

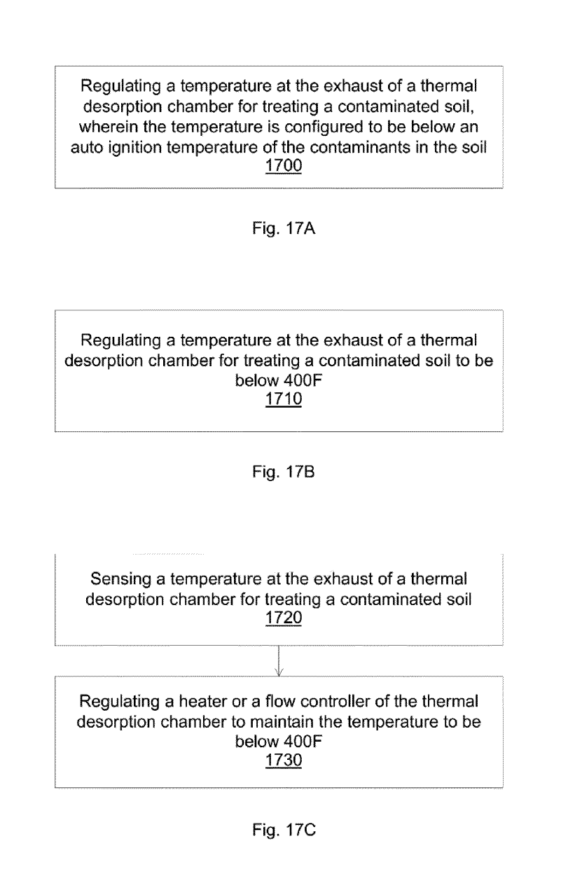

FIG. 17A-17C illustrate flow diagrams for thermal desorption processes, according to one or more embodiments.

In FIG. 17A, operation 1700 may regulate a temperature at the exhaust of a thermal desorption chamber for treating a contaminated soil 182, wherein the temperature is configured to be below an auto ignition temperature of the contaminants in the soil. In FIG. 17B, operation 1710 may regulate a temperature at the exhaust of a thermal desorption chamber for treating a contaminated soil 182 to be below 400 F (204 C) or 500 F (260 C). In FIG. 17C, operation 1720 may sense a temperature at the exhaust of a thermal desorption chamber for treating a contaminated soil 182. Operation 1730 may regulate a heater or a flow controller of the thermal desorption chamber to maintain the temperature to be below 400 F or 500 F.

In one or more embodiments, systems and methods are provided to provide a safe conveyance of potential explosive vapors from the treatment chamber, e.g., the soil box to the exhaust gas treatment equipment, e.g., a heat exchanger. The safe transport of hydrocarbon vapors, while maintaining a fast treatment cycle of the evaporative desorption process, especially for high level contaminated soil 182, may include keeping the treatment gases below auto ignition temperature, maintaining porous flow, rapid cooling, maintaining cool chase way skin temperatures and isolating critical sections of the conveyance assembly. The safe conveyance can treat hydrocarbon contaminants with high concentration, e.g., up to 30% and higher, and may recover liquid cracked crude oil.

In one or more embodiments, systems and methods are provided to regulate a hydrocarbon concentration of the exhaust gas of the thermal desorption chamber to be outside the range of flammability of the hydrocarbons. An input flow of the treatment gas, such as air, to the thermal desorption chamber can be adjusted in a controlled manner to maintain the exhaust gas in a condition that is outside the flammable mixture concentration envelope for the contaminants of interest. The contaminants can include different types of hydrocarbons with different flammability range, so the treatment gas flow can be maintained between 5 vol % and 15-30 vol %, such as between 5 vol % and 25 vol % or between 5 vol % and 20 vol %, depending on the soil conditions.

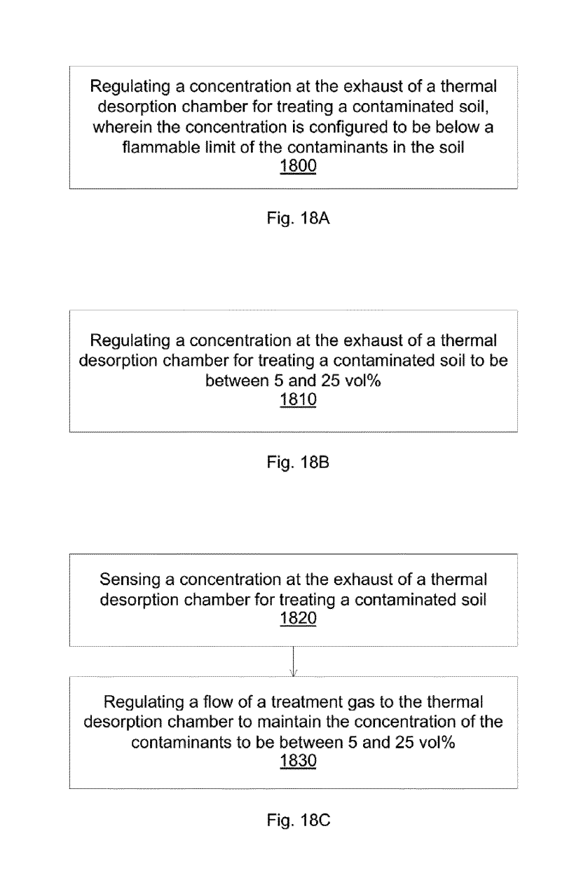

FIG. 18A-18C illustrate flow diagrams for thermal desorption processes, according to one or more embodiments.

In FIG. 18A, operation 1800 may regulate a concentration at the exhaust of a thermal desorption chamber for treating a contaminated soil 182, wherein the concentration is configured to be below a flammable limit of the contaminants in the soil. In FIG. 18B, operation 1810 may regulate a concentration at the exhaust of a thermal desorption chamber for treating a contaminated soil 182 to be between 5 and 25 vol %, between 5 and 20 vol %, or between 5 and 15 vol %. In FIG. 18C, operation 1820 may sense a concentration at the exhaust of a thermal desorption chamber for treating a contaminated soil 182. Operation 1830 may regulate a flow of a treatment gas to the thermal desorption chamber to maintain the concentration of the contaminants to be between 5 and 25 vol %, between 5 and 20 vol %, or between 5 and 15 vol %.

In one or more embodiments, systems and methods are provided to prevent damage to property and personnel, e.g., by directing flame propagation and explosion fronts to a relief chimney. The soil box itself can act as an explosion arrestor due to the porous media and mass, and therefore can be inherently safe from explosion hazard. The conveyance from the exit of the thermal desorption chamber to the heat exchanger can have isolation and venting capabilities to handle a potential conflagration event. The downstream portion of the conveyance can have a passive isolation valve just before the vapor treatment system. The passive isolation valve can be open during normal operations and close during a conflagration event. For example, the isolation valve can be configured to close when sensing flame propagation and explosion fronts. The isolation valve, when closed, can stop the explosion fronts from propagating to the downstream equipment. In addition, a pressure relief valve can be provided before the isolation valve. For example, immediately before the passive isolation valve, the conveyance can be equipped with a rupture disc and vent system that directs any potential explosion upwards in a safe direction. The pressure relief valve can be configured to open when the isolation valve is close to guide the flame propagation and explosion fronts to a safe exhaust. The conveyance is constructed with durable steel to withstand potential conflagration events.

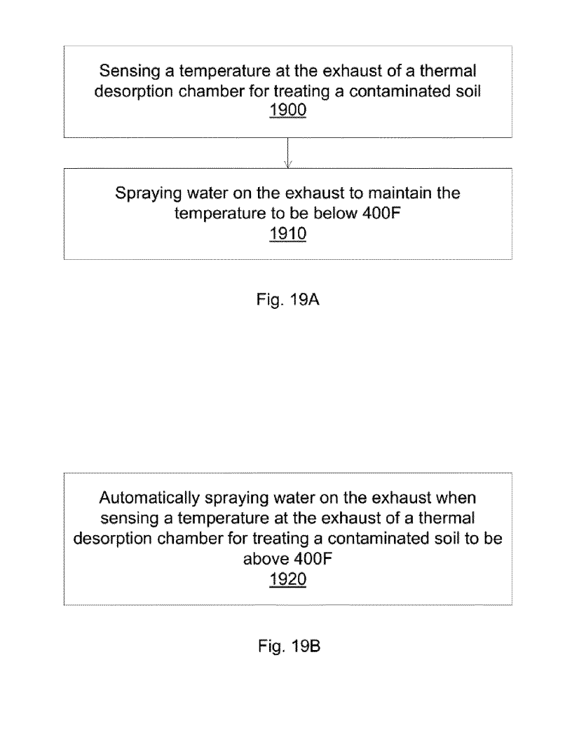

FIG. 19A-19B illustrate flow diagram for flame propagation and explosion prevention, according to one or more embodiments. In FIG. 19A, operation 1900 may sense a temperature at the exhaust of a thermal desorption chamber for treating a contaminated soil 182. Operation 1910 may spray a substance such as a liquid of any temperature, such as a cooling fluid, such as water or chilled oil on the exhaust to maintain the temperature to be below 400 F. The liquid may be at any temperature such as room temperature.

In FIG. 19B, operation 1920 may automatically spray a substance, such as a liquid of any temperature, such as a cooling fluid, such as water on the exhaust when sensing a temperature at the exhaust of a thermal desorption chamber for treating a contaminated soil 182 to be above 400 F.

In one or more embodiments, systems and methods are provided to restrict the mean free paths of the exhaust gas exiting the thermal desorption chamber, e.g., to limit the flame propagation and explosion fronts. The mean free path of the exhaust gas flow can be less 10 mm, less than 5 mm, less than 2 mm, or less than 1 mm. The mean free path can be the average of the traveled distances of the gas molecules between collision. For example, the mean free path can be the average of the gaps between materials in the exhaust conduit. A section of the gas exhaust conduit from the thermal desorption chamber can be filled with a porous media, which can assist in reducing or eliminating the potential explosion hazard in the conduit. The sizes of the conduit and the porous media can be designed to provide adequate flow conductance of the exhaust gas from the thermal desorption chamber to the treatment section. For example, the cross sectional area of the exhaust line can be large enough to overcome the head loss associated with porous flow.

The exhaust line may also be equipped with a sump pump to continuously remove any condensed hydrocarbon. The recovered liquid hydrocarbon condensate can be pumped through a cooled line and transported to a recovery tank

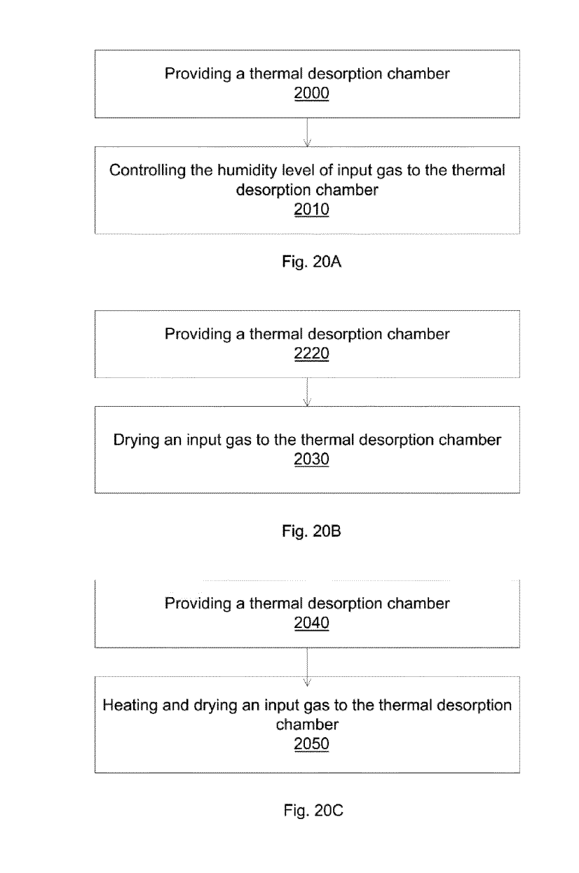

FIG. 20A-20C illustrate flow diagrams for thermal desorption processes, according to one or more embodiments.

In FIG. 20A, operation 2000 may provide a thermal desorption chamber, such as a container filled with contaminated soil 182. The thermal desorption chamber can accept a heated input gas, e.g., pre-treatment gas, for desorbing the contaminants from the soil. In operation 2010, the humidity level of the input gas may be controlled to achieve a performance improvement of the thermal desorption process. The humidity level of the input gas can be controlled to be less than 10% or less than 5%.

In FIG. 20B, operation 2020 may provide a thermal desorption chamber. In operation 2030, an input gas to the thermal desorption chamber may be dried to achieve a performance improvement of the thermal desorption process. The input gas may also be heated, either before or after being dried. The input gas may be dried to have less than 10% humidity or less than 5% humidity.

In FIG. 20C, operation 2040 may provide a thermal desorption chamber. In operation 2050, an input gas to the thermal desorption chamber may be dried and heated to achieve a performance improvement of the thermal desorption process. The input gas may be dried to have less than 10% humidity or less than 5% humidity. The input gas may be heated to a temperature of less than 1200 F or less than 1000 F.

In one or more embodiments, feedback control for a thermal desorption process are provided, e.g., to conserve energy, limit costs, and achieve high throughput. For example, temperature of the exhaust gas can be monitored, and can be used to regulate the flow rate and temperature of the input gas. Alternatively or in addition, feed forward process optimizations can be used. Exhaust temperature curves from previous batches can be used to assist the currently measured exhaust temperature to provide better performance.

In one or more embodiments, systems and methods are provided to regulate an input gas, e.g., temperature and flow rate, to a thermal desorption chamber. The regulation can be based on time, on data from previous processes, or on measured temperature of the exhaust gas of the thermal desorption chamber. A temperature measurement device, such as a thermocouple, can be placed at or near the exhaust line of the thermal desorption chamber to measure the temperature of the treatment gas that exits the chamber. The measured temperature can be used to control a thermal energy input to the thermal desorption chamber, e.g., by regulating a heater that heats the input gas or regulate a blower that controls the flow of the input gas. The contaminants can include different types of hydrocarbons, so a temperature between 250 F and 150 F, such as 212 F, can be used to change the flow rate or the temperature of the input gas.

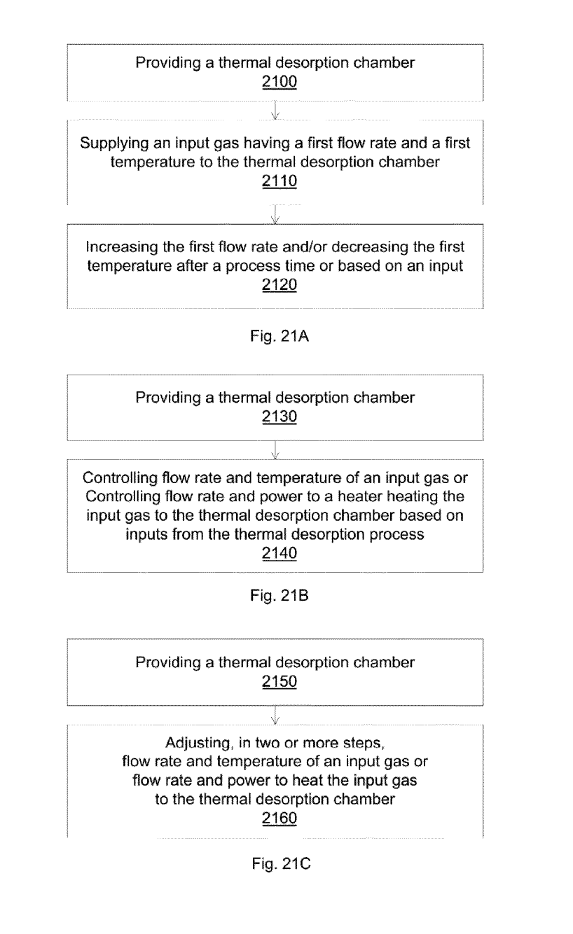

FIG. 21A-21C illustrate flow diagrams for thermal desorption processes, according to one or more embodiments.

In FIG. 21A, operation 2100 may provide a thermal desorption chamber, such as a container filled with contaminated soil 182. The thermal desorption chamber can accept an input gas for desorbing the contaminants from the soil. In operation 2110, an input gas having a first flow rate and a first temperature may be supplied to the thermal desorption chamber. The first flow rate may be provided by a blower assembly having a power or a speed. The first temperature may be provided by a heater assembly having a heating power.

In one or more embodiments, the first temperature may be an optimal temperature for a thermal desorption process. For example, the first temperature may be a maximum temperature that may be provided by the heater assembly, e.g., at about 1000 F to 1500 F.

In one or more embodiments, the first flow rate may be an optimal flow rate for a thermal desorption process. For example, the first flow rate may be less than a maximum flow rate of the blower assembly, or less than a flow capacity of the effluent treatment. The first flow rate may also be a maximum flow rate of the blower assembly, or a maximum flow capacity of the effluent treatment.

In operation 2120, the first flow rate of the input gas may be increased and/or the first temperature of the input gas may be decreased after a process time or based on an input.

In one or more embodiments, the temperature of the input gas may be the temperature of the input gas before entering the thermal desorption chamber. The input gas may be heated in the thermal desorption chamber, e.g., by the oxidation reaction of the hydrocarbon contaminants in the contaminated soil 182.

In one or more embodiments, the temperature of the input gas, or the heater power to the heater assembly may be decreased or turned off, e.g., the heater power is turned off and the input gas has the same temperature before entering the heater assembly. The heater power can be decreased, e.g., to between 20 and 80% of the previous power. The reduction in power may be based on the thermal energy released by the oxidation of the hydrocarbon contaminants in the contaminated soil 182.

In one or more embodiments, the flow rate of the input gas may be increased, e.g., to an optimal flow rate for the thermal desorption process, to a maximum flow rate that can be provided by the blower, or to a maximum flow rate that the downstream effluent treatment can handle.

In FIG. 21B, operation 2130 may provide a thermal desorption chamber, such as a container filled with contaminated soil 182. In operation 2140, input gas characteristics can be controlled, e.g., the flow rate and/or the temperature of the input gas, based on inputs from the current thermal desorption process, or from cumulated data from previous processes. Alternatively, the flow rate of the input gas and/or the heater power of the heater assembly can be controlled.

In FIG. 21C, operation 2150 may provide a thermal desorption chamber, such as a container filled with contaminated soil 182. In operation 2160, input gas characteristics may be adjusted in two or more steps. For example, the flow rate and/or the temperature of the input gas, or the flow rate of the input gas and/or the heater power of the heater assembly, can be adjusted based on inputs from the current thermal desorption process, or from cumulated data from previous processes.

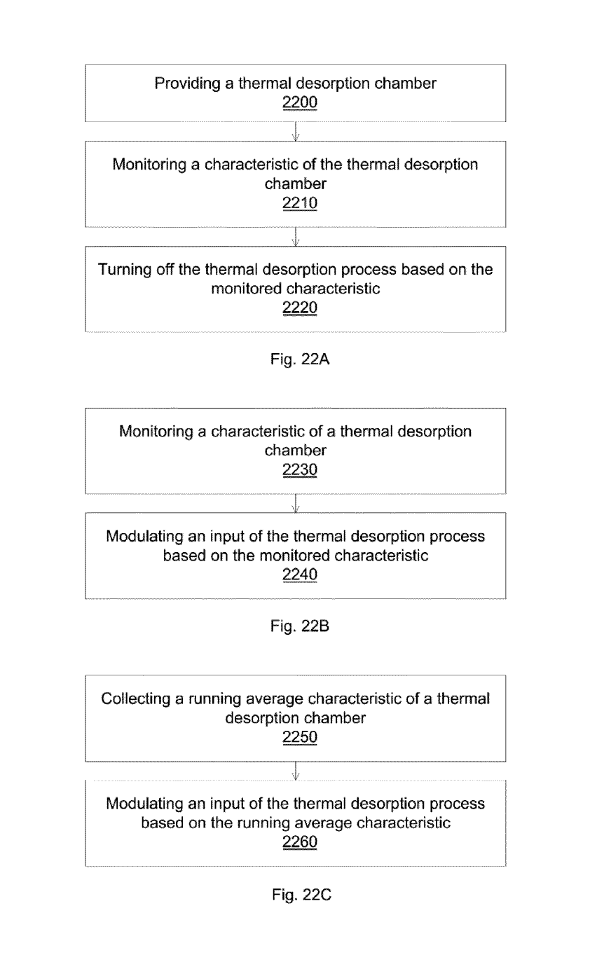

FIG. 22A-22C illustrate flow diagrams for thermal desorption processes, according to one or more embodiments.

In FIG. 22A, operation 2200 may provide a thermal desorption chamber, such as a container filled with contaminated soil 182.

In operation 2210, a characteristic of the thermal desorption process may be monitored, such as a temperature of the exhaust gas, an oxygen concentration of the exhaust gas, a pressure of the exhaust gas, a gas constituents of the exhaust gas, a humidity of the exhaust gas, a flammability of the exhaust gas.

In operation 2220, the thermal desorption process may be turned off at a time determined by the monitored characteristic. For example, a rate of change of the exhaust gas temperature can be an indication of the time that the treatment can be completed, e.g., the end point of the thermal desorption process, thus a monitoring of the exhaust gas temperature can identify the completion time of the process or certain aspect or step of the process such as pyrolysis or certain absorption level. Knowing the end point of the process, various inputs to the process (such as flow rate of the input gas, or the heater power of the heater assembly, which can be related to the temperature of the input gas) can be regulated to provide a smooth transition to the end of the process with minimal power consumption and/or fastest throughput.

In FIG. 22B, a feedback operation may be provided for the thermal desorption process. In operation 2230, a characteristic of a thermal desorption chamber may be monitored, such as a temperature of the exhaust gas, an oxygen concentration of the exhaust gas, a pressure of the exhaust gas, a gas constituents of the exhaust gas, a humidity of the exhaust gas, a flammability of the of the exhaust gas. In operation 2240, an input to the thermal desorption process may be modulated or regulated based on the monitored characteristics. For example, when the temperature of the exhaust gas reaches a certain temperature, such as between 200 and 220 F, a heater power may be reduced or turned off to reduce the temperature of the input gas. Similarly, a flow rate of the input gas may be increased to increase the reaction rate to provide a faster treatment process.

In FIG. 22C, a feed forward operation may be provided for the thermal desorption process. In operation 2250, a characteristic of a thermal desorption chamber, e.g., the data from previous thermal desorption processes, may be collected. The characteristic may be a running average of the exhaust temperature, or a rate of change of the exhaust temperature. Other characteristics may be collected, such as an oxygen concentration of the exhaust gas, a pressure of the exhaust gas, a gas constituents of the exhaust gas, a humidity of the exhaust gas, a flammability of the of the exhaust gas. In operation 2260, an input to the thermal desorption process may be modulated or regulated based on the collected characteristics, such as the running average data.

In one or more embodiments, behaviors of thermal desorption processes may be used to optimize the performance of the thermal desorption process, e.g., different contaminated soils may have different behaviors with respect to the thermal desorption process; high concentration contaminated soil may exhibit oxidation burning characteristics, which can generate a significant thermal energy in the thermal desorption process.

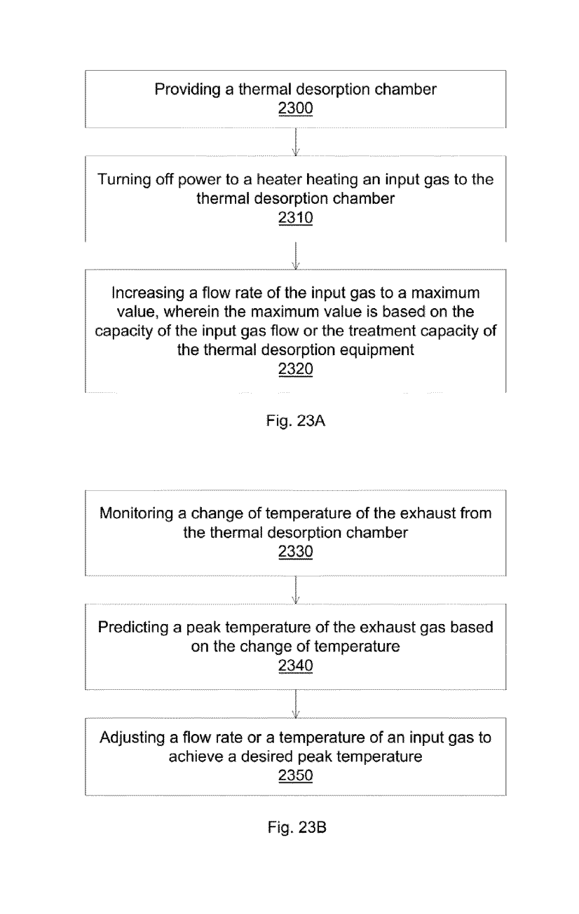

FIG. 23A-23B illustrate flow diagrams for thermal desorption processes, according to one or more embodiments.

In FIG. 23A, a process flow for high concentration soil may be provided, in which after an initial heating, e.g., for the exhaust gas to reach about 200-220 F, the heating may be supplied by the contaminants in the soil, and thus the input power can be turned off or reduced. Further, the reaction may highly depend on the flow rate, thus a flow rate for the input gas can increase to improve the throughput of the thermal desorption process. Operation 2300 may provide a thermal desorption chamber, such as a container filled with contaminated soil 182. In operation 2310, power to a heater heating an input gas to the thermal desorption chamber may be turned off or reduced. For example, the power may be reduced by 20-80%. Alternatively, the temperature of the input gas may be reduced, e.g., by 20-80%. In operation 2320, a flow rate of the input gas may be increased, e.g., to a maximum value, wherein the maximum value is based on the capacity of the input gas flow or the treatment capacity of the thermal desorption equipment.

In FIG. 23B, a process flow for high concentration soil may be provided to prevent temperature of the exhaust gas to be above the safety temperature of the effluent treatment. Operation 2330 may monitor a change of temperature of the exhaust from the thermal desorption chamber. Operation 2340 may predict a peak temperature of the exhaust gas based on the change of temperature. Operation 2350 may adjust a flow rate or a temperature of an input gas to achieve a desired peak temperature. For example, lower flow rate may lower the peak temperature. The flow rate may be reduced by 20-80%. The flow rate may be turned off. Power to a heater heating an input gas to the thermal desorption chamber may be turned off or reduced. For example, the power may be reduced by 20-80%. Alternatively, the temperature of the input gas may be reduced, e.g., by 20-80%.

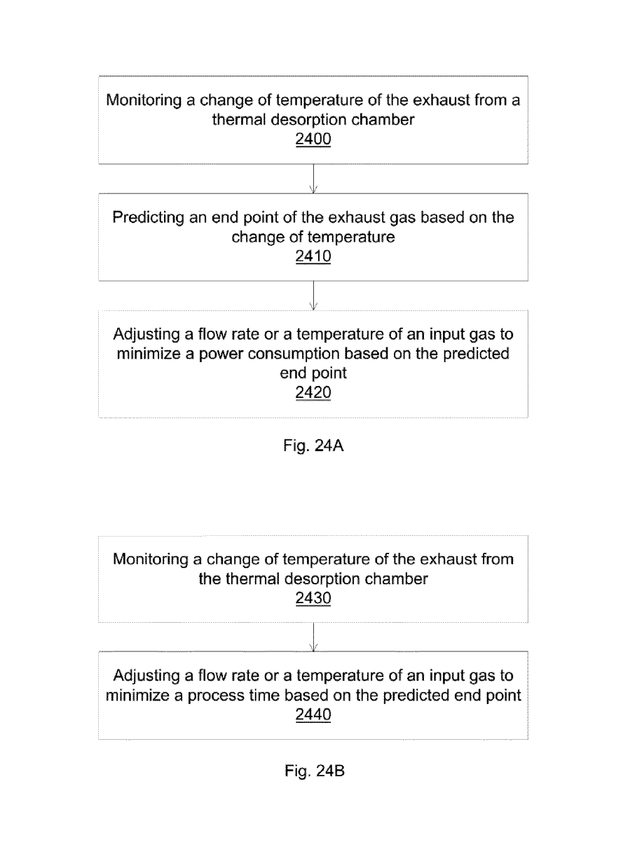

FIG. 24A-24B illustrate flow diagrams for thermal desorption processes, according to one or more embodiments.

In FIG. 24A, a process flow for a contaminated soil 182 may be provided, e.g., for high concentration or low concentration, for clay soil or for unsaturated granular soil. Operation 2400 may monitor a change of temperature of the exhaust from a thermal desorption chamber. Operation 2410 may predict an end point of the exhaust gas based on the change of temperature. Operation 2420 may adjust a flow rate or a temperature of an input gas to minimize power consumption based on the predicted end point. For example, a heater power heating the input gas may be turned off or reduced at a certain time before the end point of the thermal desorption process. The flow rate of the input gas may be turned off. The flow rate may be reduced by 2080%. The power may be reduced by 20-80%. Alternatively, the temperature of the input gas may be reduced, e.g., by 20-80%.

In FIG. 24B, operation 2430 may monitor a change of temperature of the exhaust from the thermal desorption chamber. Operation 2440 may adjust a flow rate or a temperature of an input gas to minimize a process time based on the predicted end point. For example, high flow rate or high temperature of the input gas can be used to improve the throughput.

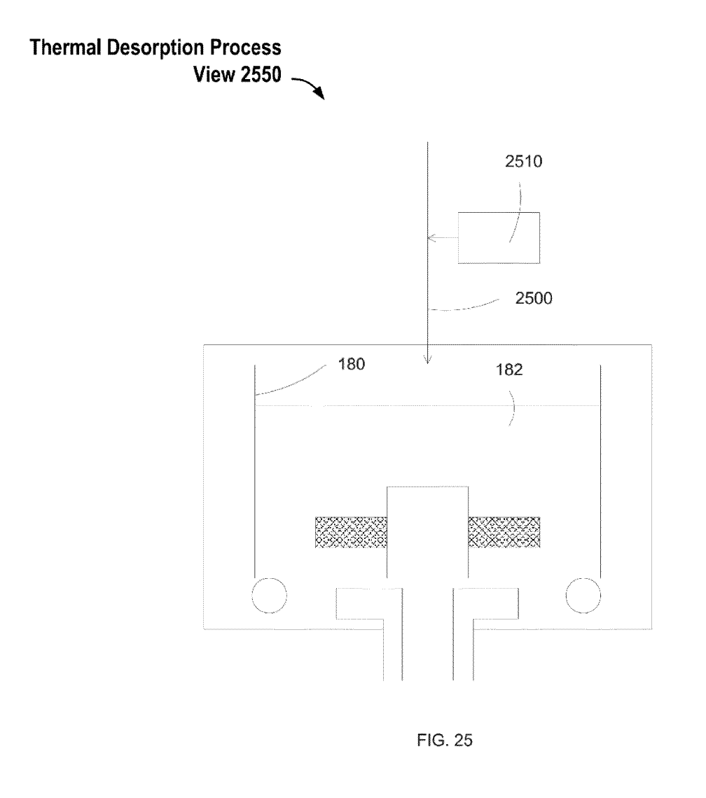

FIG. 25 illustrates a thermal desorption process view 2550 showing a process with additives, according to one or more embodiments. The soil box 180 may be configured to hold the contaminated soil 182, and may be placed in the treatment chamber 158. A hot gas 2500 may be provided to the treatment chamber, e.g., to heat the soil to vaporize the volatile contaminants. An additive reservoir 2510 may be coupled to the hot gas 2500 delivery path to supply additive, either in gaseous, vapor or liquid form, e.g., for gaseous or vapor, reservoir 185 may provide the gases or vapor directly to the flow stream of hot gas 2500. The additives may be heated. For liquid, the reservoir may provide sprayed liquid, e.g., liquid in droplet form, to the flow stream, or the reservoir may accept the flow stream to bubble liquid to the flow stream.

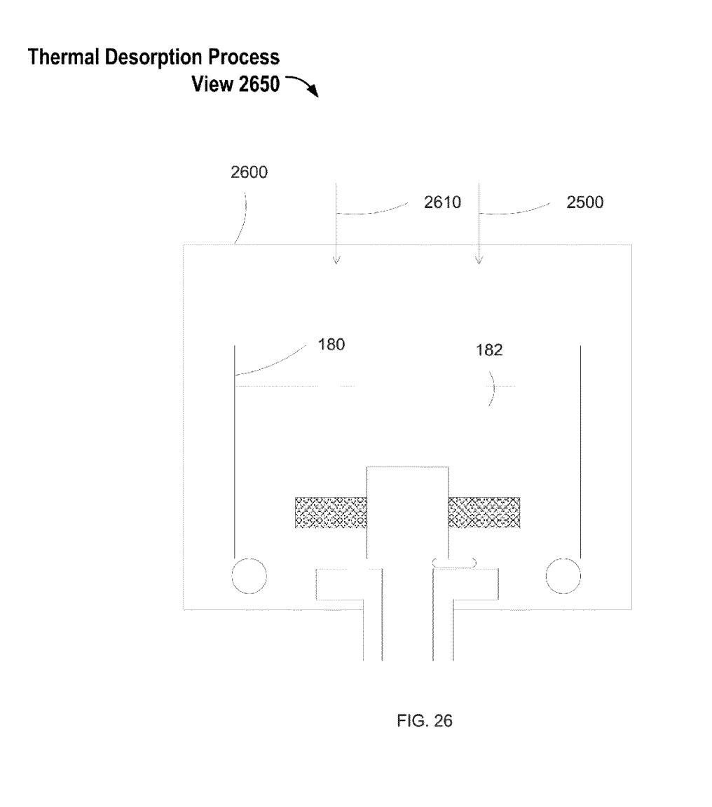

FIG. 26 illustrates another thermal desorption process view 2650 showing a process with additives, according to one or more embodiments. The soil box 180 may be configured to hold the contaminated soil 182, and may be placed in the treatment chamber 158. The hot gas 2500 may be provided to the treatment chamber, for example, to heat the soil to vaporize the volatile contaminants. An additive flow stream 2600 may also be provided to supply additive, either in gaseous, vapor or liquid droplet form, e.g., gaseous or vapor flow stream 2610 may provide the gases or vapor directly to the treatment chamber, it may be in nozzle or in showerhead configuration. The additives may be heated. For liquid, the flow stream 285 may provide sprayed liquid, e.g., liquid in droplet form, to the treatment chamber, or the flow stream may include carrier gas bubbling liquid additive to the treatment chamber.

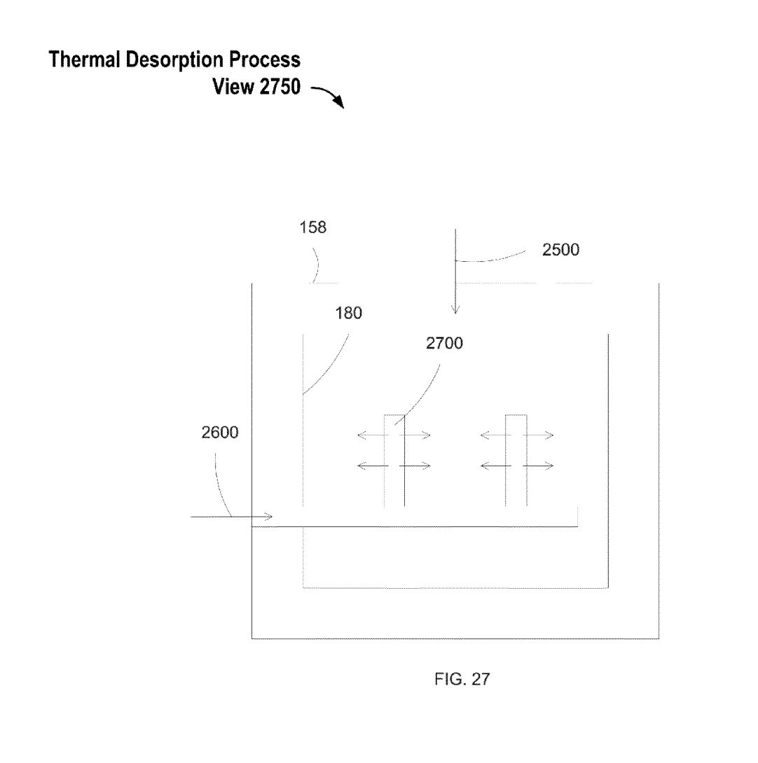

FIG. 27 illustrates another thermal desorption process view 2750 showing a process with additives, according to one or more embodiments. The soil box 180 may be configured to hold contaminated soil, and may be placed in the treatment chamber 158. The hot gas 2500 may be provided to the treatment chamber, for example, to heat the soil to vaporize the volatile contaminants. The additive flow stream 2600 may also be provided to supply additive, either in gaseous, vapor or liquid droplet form. The additives may be heated. An additive delivery lines 2700 may be provided to the inside of the soil, processing the soil from the inside of the soil outward.

What is claimed is:

1. A thermal desorption soil remediation system, comprising:
a treatment chamber; a treatment gas exit pathway, wherein treatment gas exits the treatment chamber; a carbon monoxide concentration monitoring means, and wherein an adjustment of at least one of an oxygen concentration of the treatment gas and a temperature of the treatment gas is based on an input from the carbon monoxide concentration monitoring means.

2. The system of claim 1, further comprising:
wherein the carbon monoxide concentration monitoring means monitors carbon monoxide at at least one of the treatment gas exit pathway, a heat exchanger, a heat exchanger cooler, a phase separator, a gas extraction fan, and a flame arrester.

3. The system of claim 1, further comprising:
wherein the oxygen concentration of the treatment gas is adjusted to at, above or below a threshold when the carbon monoxide concentration is at, above or below a threshold.

4. The system of claim 1, further comprising:
wherein the temperature of the treatment gas is adjusted to at, above or below a threshold when the carbon monoxide concentration is at, above or below a threshold.

5. A thermal desorption soil remediation system, comprising:
a soil box; an insulated treatment chamber, wherein the soil box is inserted; a pre-treatment gas inlet, wherein heated pre-treatment gas enters the treatment chamber;
a post-treatment gas exit pathway, wherein post-treatment gas exits the treatment chamber,
wherein the post-treatment gas exit pathway is coupled to a through opening in the soil box;
a carbon monoxide detecting means; a carbon monoxide concentration monitoring means communicatively coupled to a data processing system, wherein the data processing system comprises an algorithm,
wherein the algorithm uses at least one datum from the carbon monoxide concentration monitoring means to calculate an adjustment of a parameter to achieve at least one of an aversion of a combustion within the treatment chamber and an optimum efficiency of a desorption rate;
at least one electronic controlling device communicatively coupled to the data processing system, and
wherein the at least one electronic controlling device is used to adjust the a parameter based on a calculation of the algorithm through controlling a corresponding apparatus.

6. The system of claim 5, further comprising:
wherein the carbon monoxide concentration monitoring means monitors carbon monoxide at the post-treatment gas exit pathway.

7. The system of claim 5, further comprising:
wherein the a parameter comprises at least one of an oxygen concentration of the pre-treatment gas, an oxygen concentration of the post-treatment gas, a hydrocarbon concentration of a pre-treatment gas, a hydrocarbon concentration of a post-treatment gas, a temperature of the pre-treatment gas, a temperature of the post-treatment gas, a flow of the pre-treatment gas, a flow of the post-treatment gas, a humidity of the pre-treatment gas, and a humidity of the post-treatment gas.

8. The system of claim 7, further comprising:
wherein the oxygen concentration of the pre-treatment gas is adjusted to be within a range when the carbon monoxide concentration is at, above or below a threshold.

9. The system of claim 8, further comprising:
wherein lowering the oxygen concentration of the pre-treatment gas requires burning oxygen gas from the pre-treatment gas prior to injecting the pre-treatment gas into the treatment chamber.

10. The system of claim 7, further comprising:
wherein the temperature of the pre-treatment gas is adjusted to be at, above or below a threshold when the carbon monoxide concentration is at, above or below a threshold.

11. The system of claim 10, further comprising:
wherein lowering the temperature of the pre-treatment gas requires turning off a heater used to heat the pre-treatment gas, and inletting atmospheric air through an air chimney.

12. A method comprising:
heating a hydrocarbon-contaminated soil with a pre-treatment gas in an insulated treatment chamber;
removing a post-treatment gas from the treatment chamber containing hydrocarbon contaminants; and
monitoring a carbon monoxide concentration through a carbon monoxide concentration monitoring means communicatively coupled to a data processing system, wherein the data processing system comprises an algorithm.

13. The method of claim 12, further comprising:
adjusting a parameter based on a calculation of the algorithm through controlling a corresponding apparatus using an electronic controlling device communicatively coupled to the corresponding apparatus, and
wherein the electronic controlling device is communicatively coupled to the data processing system.

14. The method of claim 13, further comprising:
wherein the algorithm uses at least one datum from the carbon monoxide concentration monitoring means to calculate the calculation, and
wherein adjusting the a parameter to achieve at least one of an aversion of a combustion within the treatment chamber and an optimum efficiency of a desorption rate.

15. The method of claim 14, further comprising:
wherein monitoring the carbon monoxide concentration occurs at at least one of a post-treatment gas exit pathway, a heat exchanger, a heat exchanger cooler, a phase separator, a gas extraction fan, and a flame arrester.

16. The method of claim 15, further comprising:
wherein the a parameter comprises at least one of an oxygen concentration of the pre-treatment gas, an oxygen concentration of the post-treatment gas, a hydrocarbon concentration of the pre-treatment gas, a hydrocarbon concentration of the post-treatment gas, a temperature of the pre-treatment gas, a temperature of the post-treatment gas, a flow of the pre-treatment gas, a flow of the post-treatment gas, a humidity of the pre-treatment gas, and a humidity of the post-treatment gas.

17. The method of claim 16, further comprising:
wherein the oxygen concentration of the pre-treatment gas is adjusted to be within a range when the carbon monoxide concentration is at, above or below a threshold.

18. The method of claim 17, further comprising
wherein lowering the oxygen concentration of the pre-treatment gas requires burning oxygen gas from the pre-treatment gas.

19. The method of claim 18, further comprising:
wherein the temperature of the pre-treatment gas is adjusted to at, above or below a threshold when the carbon monoxide concentration is at, above or below a threshold.

20. The method of claim 19, further comprising:
wherein lowering the temperature of the pre-treatment gas requires turning off a heater used to heat the pre-treatment gas, and inletting atmospheric air through an air chimney.
